(19) United States
(12) Patent Application Publication
(10) Pub. No.: US 2019/0271944 A1
(43) Pub. Date: Sep. 5, 2019

(54) SYSTEMS, DEVICES, AND METHODS FOR CONTROLLABLE HOLOGRAM PLAYBACK SHIFTING

(71) Applicant: North Inc., Kitchener (CA)

(72) Inventors: John Cormier, Waterloo (CA); Laleh Mokhtarpour, Kitchener (CA); Sylwia Agnieszka Lyda, Waterloo (CA); I-Hsiang Albert Chen, Toronto (CA)

(21) Appl. No.: 16/290,645

(22) Filed: Mar. 1, 2019

Related U.S. Application Data
(60) Provisional application No. 62/637,059, filed on Mar. 1, 2018.
(60) Provisional application No. 62/702,657, filed on Jul. 24, 2018.

(51) Int. Cl. G03H 1/26; G03H 1/02; G02B 27/01

(52) U.S. Cl. CPC G03H 1/265; G02B 2027/0174; G02B 27/0172; G03H 1/0256

(57) ABSTRACT

Systems, devices, and methods for controlled hologram playback shifting are described. The playback of a hologram may be shifted to a longer wavelength by diffusing donor material into the hologram in a controlled manner. A hologram may include a set of fringes, holographic recording medium and donor material. An apparatus to controllable shift playback angle of a hologram can include a hologram film holder, donor film holder, one or more light sources, light sensor, and curing lamp. A method may include monitoring playback light until an amount of playback shift occurs, and in response fixing a piece of hologram film and physically de-coupling a donor film therefrom.

### TECHNICAL FIELD

The present systems, devices, and methods generally relate to holograms and particularly relate to holograms with shifted playback wavelengths or angles.

### BACKGROUND

### Description of the Related Art

### Holograms

A hologram is a recording of a light field, with a typical light field comprising a pattern of optical fringes generated by interference between two beams of laser light. The hologram is made up of physical fringes, where physical fringes comprise variations in the refractive index or absorbance of the holographic recording medium.

During hologram playback, at least a portion of the light field used to record a hologram may be recreated by illuminating the hologram with laser light. If the laser light comprises the same wavelength and angle as the first beam of laser light used to record the hologram, and the fringes have not been altered after recording, the holographic medium will diffract laser light with the same angle and pattern as the second beam of laser light used to record the hologram. The intensity of the diffracted light is determined by the efficiency of the hologram, where the efficiency of the hologram is the fraction of the light of the first beam of laser light that is diffracted in the direction of the second beam of laser light; hologram efficiency may be in a range from 0-100%. The efficiency of a hologram depends on both the angle and the wavelength of light used to illuminate the holographic medium. Multiple holograms may be recorded in a single holographic recording medium, the multiple holograms comprising a multiplexed hologram.

### Hologram Recording

A pattern of optical fringes may be generated by the interference of two beams of laser light; the two beams of laser light may be created by splitting a single beam of laser light. The two beams of laser light are typically referred to as the object beam and the reference beam. Hologram recording is typically designed such that, during playback, the recorded hologram is illuminated with laser light recreating the reference beam and the object beam is then replicated by the hologram.

Holograms are recorded in a holographic recording medium which may be a silver halide photographic emulsion, dichromated gelatin, photopolymer, or other physical media. Silver halide emulsions record a hologram as a pattern of absorbance and reflectance of light. Dichromated gelatin and photopolymer both record a hologram as a pattern of varying refractive index. Recording a hologram as a pattern of refractive index is advantageous since all of the illuminating laser light may theoretically leave the hologram; no light is necessarily absorbed by the hologram.

### Laser Projectors

A projector is an optical device that projects or shines a pattern of light onto another object (e.g., onto a surface of another object, such as onto a projection screen) in order to display an image or video on that other object. A projector necessarily includes a light source, and a laser projector is a projector for which the light source comprises at least one laser. The at least one laser is temporally modulated to provide a temporal pattern of laser light and usually at least one controllable mirror is used to spatially distribute the modulated temporal pattern of laser light over a two-dimensional area of another object. The spatial distribution of the modulated temporal pattern of laser light produces a series of images at or on the other object. In conventional laser projectors, the at least one controllable mirror may include: a single digital micromirror (e.g., a microelectromechanical system (“MEMS”) based digital micromirror) that is controllably rotatable or deformable in two dimensions, or two digital micromirrors that are each controllably rotatable or deformable about a respective dimension, or a digital light processing (“DLP”) chip comprising an array of digital micromirrors.

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

### BRIEF SUMMARY

A hologram with controllably shifted playback may be summarized as including: a first surface; a second surface opposite the first surface; a set of fringes disposed between the first surface and the second surface; holographic recording medium (“HRM”) material, where the concentration of HRM material is at least approximately constant between the first surface and the second surface; and donor material, where the concentration of donor material is at least approximately constant between the first surface and the second surface.

The hologram may include a reflection hologram. The hologram may possess an incident playback angle that is at least approximately constant between the first surface and the second surface. The hologram may possess an incident playback angle greater than 45 degrees. The may possess a redirection angle greater than 45 degrees. The hologram may possess a playback wavelength that is at least approximately constant between the first surface and the second surface. The hologram may possess a playback wavelength greater than 680 nanometers. The set of fringes may possess a slant angle that is at least approximately constant between the first surface and the second surface. The set of fringes may possess a fringe spacing that is at least approximately constant between the first surface and the second surface. The hologram may comprise a wavelength-multiplexed hologram. The wavelength-multiplexed hologram may include a red hologram, a green hologram, and a blue hologram.

An apparatus for controllable shifting of the playback angle of a hologram may be summarized as including: a hologram film holder arranged to controllably physically couple a hologram film to a donor film, wherein the hologram film holder is transparent; a donor film holder arranged to controllably physically couple the donor film to the hologram film; a first light source positioned and oriented to illuminate at least a portion of the hologram film when held by the hologram holder with a first beam of incident playback light; a first light sensor positioned and oriented to measure an intensity of playback light emanating from the hologram film when held by the hologram film holder; and a controllable curing lamp positioned and oriented to illuminate the hologram film with light when the hologram film is held by the hologram film holder, wherein the range of wavelengths of light emitted by the curing lamp is different from the range of wavelengths of light emitted by the first light source.

The first light source may include a monochromatic light source. The first light source may include a multi-wavelength light source. The first light sensor may include a single-wavelength light sensor. The apparatus may include a second light source. The apparatus may include a second light sensor. The apparatus may include a temperature sensor sufficiently proximate the hologram film holder to measure the temperature of the hologram film holder. The apparatus may include a controllable heat source sufficiently proximate the hologram film holder to increase the temperature of the hologram film holder. The apparatus may include a controllable cold source sufficiently proximate the hologram film holder to decrease the temperature of the hologram film holder. The angle between the first light source and the first light sensor may be greater than 140 degrees. The first light source may include an infrared light source.

The hologram film may include a portion of a roll of hologram film, wherein the roll of hologram film may be positioned and oriented to hold said portion of the roll of hologram film in the hologram film holder; the donor film may include a portion of a roll of donor film, wherein the roll of donor film may be positioned and oriented to hold said portion of the roll of donor film in the donor film holder; the hologram film holder may be arranged to controllably physically couple the hologram film to the donor film by placing tension on the roll of hologram film; and the donor film holder may arranged to controllably physically couple the donor film to the hologram film by placing tension on the roll of donor film.

The angle between the first light source and the first light sensor may be at least 90 degrees. The second light source may include a visible light source.

A method for controllable shifting of the playback of holograms may be summarized as including: physically coupling a donor film to a hologram film, wherein the donor film may include donor material, the hologram film may include a hologram, and wherein physically coupling the donor film to the hologram film may cause a first amount of donor material to diffuse from the donor film into the hologram film; monitoring a playback light of the hologram of the hologram film until a first amount of playback shifting has occurred; in response to achieving the first amount of playback shifting: fixing the hologram film; and physically de-coupling the donor film from the hologram film.

Monitoring a playback light of the hologram of the hologram film may include monitoring at least one of: a playback wavelength of the hologram of the hologram film and a playback angle of the hologram of the hologram film. Physically coupling a donor film to the hologram film may include forming an interface between the donor film and the hologram film to cause the first amount of donor material to diffuse from the donor film across the interface into the hologram film. The method may further include: monitoring the playback light of the hologram of the hologram film until an additional amount of playback shifting has occurred; and equilibrating donor material within the hologram film, wherein equilibrating donor material within the hologram film may include causing diffusion of donor material within the hologram film absent diffusion of donor material from the donor film into the hologram film to achieve a first amount of playback shifting; wherein physically de-coupling the donor film from the hologram film includes physically de-coupling the donor film from the hologram film in response to achieving the additional amount of playback shifting.

Monitoring the playback light of the hologram of the hologram film until an additional amount of playback shifting has occurred may include monitoring the playback light of the hologram of the hologram film until a first amount of bandwidth broadening has occurred. The donor material may include curable donor material, and wherein fixing the hologram film may include curing the curable donor material. The hologram film may include a first photopolymer film, the donor film may include a second photopolymer film, and physically coupling a donor film to the hologram film may include physically coupling the second photopolymer film to the first photopolymer film. Monitoring a playback light of the hologram of the hologram film may include illuminating the hologram film with at least one beam of monochromatic light, wherein each beam of monochromatic light may possess a respective incident angle, and measuring the intensity of the laser light diffracted by the hologram at at least one playback angle.

Monitoring a playback light of the hologram of the hologram film may include illuminating the hologram film with at least one beam of monochromatic light, wherein each beam of monochromatic light possesses a respective wavelength. Monitoring a playback light of the hologram of the hologram film may include measuring an intensity of the light played back by the hologram at at least one angle. Monitoring a playback light of the hologram of the hologram film may include measuring an intensity of the light played back by the hologram at at least one wavelength. Monitoring a playback light of the hologram of the hologram film may include illuminating the hologram film with infrared light and measuring an intensity of the infrared light diffracted by the hologram. Monitoring a playback light of the hologram of the hologram film may include illuminating the hologram film with light of a wavelength to which the donor material is insensitive.

The hologram film may include at least one plane-wave sub-hologram, and monitoring the playback light of the hologram of the hologram film may include monitoring the playback light of at least one of the at least one plane-wave sub-hologram. The method may include bleaching the hologram film. The hologram film may include a wavelength-multiplexed hologram, and monitoring the playback light of the hologram of the hologram film until a first amount of playback shifting has occurred may include monitoring the playback light of each wavelength-specific hologram comprising the hologram film until a respective first amount of playback shifting has occurred for each wavelength specific hologram comprising the hologram film.

The method may include: physically coupling an additional donor film to the hologram film to cause a second amount of donor material to diffuse from the donor film into the hologram film; monitoring the playback light of the hologram of the hologram film until a second amount of playback shifting has occurred; in response to achieving the second amount of playback shifting: fixing the second amount of donor material; and physically de-coupling the additional donor film from the hologram film. The method may include: heating at least one of: the hologram film and the donor film. The method may include: cooling at least one of: the hologram film and the donor film. The method may include: monitoring the temperature of at least one of: the hologram film and the donor film.

Monitoring a playback light of the hologram of the hologram film until a first amount of playback shifting has occurred may include monitoring a playback light of the hologram of the hologram film until the hologram of the hologram film possesses a redirection angle of at least 45 degrees. Monitoring a playback light of the hologram of the hologram film until a first amount of playback shifting has occurred may include monitoring a playback light of the hologram of the hologram film until the hologram of the hologram film possesses a playback wavelength of at least 680 nanometers.

An eyeglass lens for use in a wearable heads-up display may be summarized as including: a hologram comprising: a first surface; a second surface opposite the first surface; and a set of fringes disposed between the first surface and the second surface; holographic recording medium (“HRM”) material, where the concentration of HRM material is at least approximately constant between the first surface and the second surface; and donor material, where the concentration of donor material is at least approximately constant between the first surface and the second surface; and at least one lens portion, wherein each lens portion is physically coupled to the hologram.

The hologram may include a reflection hologram. The hologram may possess an incident playback angle that is at least approximately constant between the first surface and the second surface. The hologram may possess an incident playback angle greater than 45 degrees. The hologram may possess a redirection angle greater than 45 degrees. The hologram may possess a playback wavelength that is at least approximately constant between the first surface and the second surface. The hologram may possess a playback wavelength greater than 680 nanometers. The set of fringes may possess a slant angle that is at least approximately constant between the first surface and the second surface. The set of fringes may possess a fringe spacing that is at least approximately constant between the first surface and the second surface.

The hologram may include a wavelength-multiplexed hologram. The wavelength-multiplexed hologram may include a red hologram, a green hologram, and a blue hologram. The lens may include a light guide and an out-coupler, wherein the hologram may include a holographic in-coupler. The lens may include a light guide and an in-coupler, wherein the hologram may include a holographic out-coupler. The in-coupler may include a holographic in-coupler, the holographic in-coupler may include: a first surface; a second surface opposite the first surface; a set of fringes disposed between the first surface and the second surface; holographic recording medium (“HRM”) material, where the concentration of HRM material is at least approximately constant between the first surface and the second surface; and donor material, where the concentration of donor material is at least approximately constant between the first surface and the second surface.

A wearable heads-up display (WHUD) with an expanded may be summarized as including: a support structure; a projector; and a transparent combiner positioned and oriented to appear in a field of view of an eye of a user when the support structure is worn on a head of the user, the transparent combiner comprising: a hologram comprising: a first surface; a second surface opposite the first surface; and a set of fringes disposed between the first surface and the second surface; holographic recording medium (“HRM”) material, where the concentration of HRM material is at least approximately constant between the first surface and the second surface; and donor material, where the concentration of donor material is at least approximately constant between the first surface and the second surface; and at least one lens portion, wherein each lens portion is physically coupled to the hologram.

The hologram may include a reflection hologram. The hologram may possess an incident playback angle that is at least approximately constant between the first surface and the second surface. The hologram may possess an incident playback angle greater than 45 degrees. The hologram may possess a redirection angle greater than 45 degrees. The hologram may possess a playback wavelength that is at least approximately constant between the first surface and the second surface. The hologram may possess a playback wavelength greater than 680 nanometers. The set of fringes may possess a slant angle that is at least approximately constant between the first surface and the second surface. The set of fringes possesses a fringe spacing that is at least approximately constant between the first surface and the second surface. The hologram may include a wavelength-multiplexed hologram. The wavelength-multiplexed hologram may include a red hologram, a green hologram, and a blue hologram. The lens may include a light guide and an out-coupler, wherein the hologram includes a holographic in-coupler. The lens may include a light guide and an in-coupler, wherein the hologram includes a holographic out-coupler. The in-coupler may include a holographic in-coupler, the holographic in-coupler comprising: a first surface; a second surface opposite the first surface; a set of fringes disposed between the first surface and the second surface; holographic recording medium (“HRM”) material, where the concentration of HRM material is at least approximately constant between the first surface and the second surface; and donor material, where the concentration of donor material is at least approximately constant between the first surface and the second surface.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a cross-sectional view of an un-swollen hologram in accordance with the present systems, devices, and methods.

FIG. 2 is a cross-sectional view of a controllably playback shifted hologram in accordance with the present systems, devices, and methods.

FIG. 3A is a schematic diagram of a controllable hologram playback shifting apparatus, wherein the controllable playback shifting apparatus is arranged to maintain a donor film and a hologram film in a physically coupled state.

FIG. 3B is a schematic diagram of a controllable hologram playback shifting apparatus, wherein the controllable playback shifting apparatus is arranged to maintain a donor film and a hologram film in a physically uncoupled state.

FIG. 3C is a schematic diagram of a portion of a controllable hologram playback shifting apparatus, wherein the controllable playback shifting apparatus is arranged to maintain a donor film and a hologram film in a physically coupled state. Portions of the controllable hologram playback shifting apparatus have been omitted from FIG. 3C for clarity.

FIG. 4 is a flow-diagram showing a method of controllable playback shifting of a hologram in accordance with the present systems, devices, and methods.

FIG. 5 is a cross-sectional view of an exemplary eyeglass lens with an embedded hologram with controllably shifted playback suitable for use in a WHUD in accordance with the present systems, devices, and methods.

FIG. 6 is a partial-cutaway perspective view of a WHUD that includes an eyeglass lens with an embedded hologram with controllably shifted playback in accordance with the present systems, devices, and methods.

FIG. 7A is a cross-sectional view of an exemplary eyeglass lens suitable for use in a WHUD in accordance with the present systems, devices, and methods.

FIG. 7B is a cross-sectional view of an exemplary eyeglass lens suitable for use in a WHUD in accordance with the present systems, devices, and methods.

FIG. 7C is a cross-sectional view of an exemplary eyeglass lens suitable for use in a WHUD in accordance with the present systems, devices, and methods.

FIG. 8 is a cross-sectional view of controllably playback shifted hologram in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for controllable hologram playback shifting that, among other potential applications, have particular utility in wearable heads-up displays (“WHUDs”) including scanning laser-based WHUDs and light guide-based WHUDs.

Generally, a scanning laser-based WHUD is a form of virtual retina display in which a scanning laser projector (“SLP”) generates laser light and the laser light is redirected by a hologram in a holographic combiner into the eye of the user. The laser light generated by the projector will impinge on the hologram at an angle determined by the position of the projector relative to the hologram. The laser light is then redirected by the hologram to converge at or near an area proximate to the eye of the user. The difference between the angle of the laser light that impinges on the hologram and the angle of the laser light diffracted by the hologram is the redirection angle.

Generally, a light guide-based WHUD is a form of display in which a projector (SLP, microdisplay, dynamic light projector, etc.) generates a light signal which is in-coupled into a light guide then out-coupled from the light guide; the out-coupled light signal may then be viewed by a user. The light signal may be in-coupled and out-coupled by an in-coupling hologram and an out-coupling hologram, respectively. Due to the geometry of typical display light-guides, there is often a need for high redirection angles for both in-coupling and out-coupling.

It is advantageous that the holograms used in holographic combiners, light guide in-couplers and light guide out-couplers possess a sufficiently high redirection angle, however in practice it may be very difficult to record holograms with such high redirection angles. Typically, the redirection angle of a hologram is the same as the angle between the object beam and the reference beam used to record the hologram. If the angle of a beam of laser light is very high, measured relative to the normal of the film comprising the holographic recording medium (HRM), at least a portion of the beam of laser light may reflect off the surface of the HRM which decreases the amount of laser power available within the HRM to record the hologram; the amount of laser power available to record the hologram is further decreased at high angle due to the increase of the spot size of the laser light. Additionally, at least a portion of the beam of laser light may be totally internally reflected within the HRM. Both reflection off the surface and total internal reflection within the HRM degrade the performance of the resulting hologram. Reflections may be eliminated through the careful use of prisms and refractive index matching fluids during recording, however many typical refractive index matching fluids are toxic and/or carcinogenic; eliminating the need for refractive index matching fluids is therefore advantageous. Additionally, refractive index matching fluids are not easily compatible with continuous production methods.

When a hologram is illuminated with light the hologram may “play back” at least a portion of that light if at least a portion of said light comprises light with a wavelength and an angle that satisfy the Bragg condition for the hologram. Throughout this specification and the appended claims, the term “playback light” refers to light which impinges upon a hologram and the portion of said light that is diffracted by said hologram. Incident playback light refers specifically to the portion of playback light that is incident upon the hologram. Incident playback angle refers to the angle of the incident playback light that satisfies the Bragg condition of the hologram. Diffracted playback light refers to the light emanating from the hologram that is diffracted by the hologram. Playback angle refers to the angle of the diffracted playback light. Playback wavelength refers to the wavelength of the incident playback light that satisfies the Bragg condition of the hologram; the light diffracted by the hologram will have the same wavelength as the light incident upon the hologram since holograms are unable to change the wavelength of light during playback, only the angle of light.

Holograms which are able to diffract light when illuminated with (i.e. “play back”) laser light at infrared wavelengths are inherently difficult to record. Infrared light does not have enough energy to activate the dyes found in typical holographic recording media, so typical holographic recording media cannot be used to record infrared holograms. There is a need for a method of recording holograms with visible light that play back with infrared light.

The playback wavelength of a hologram may be increased by swelling the hologram. Swelling the hologram increases the fringe spacing and/or the slant angle of the hologram fringes comprising the hologram, and therefore swelling increases the Bragg wavelength of the swollen portion of the hologram. A change in the Bragg wavelength of a hologram typically causes a change in the Bragg angle of said hologram, where the change in angle depends on the properties of the hologram e.g. whether the hologram is a reflection or a transmission hologram. During swelling, a gradient of swelling may be initially established, where the fringes on one surface of the hologram are maximally swollen, the fringes on the opposite surface of the hologram are minimally swollen, and the swelling decreases continuously from the first to the second surface. Over time, diffusion will disperse the gradient and swelling will be constant throughout the hologram, the hologram with a dispersed swelling gradient is an equilibrated hologram.

Swelling may be achieved by diffusing donor material into a hologram and then fixing the donor material in place. The donor material may be a monomer material, where the monomer may be mono-functional (e.g. methyl methacrylate), bi-functional (e.g. ethylene glycol dimethacrylate) or with higher functionality (e.g. trimethylpropane triacrylate). The donor material may be fixed by curing the donor material, where curing includes photo-curing, thermal curing, or other forms of curing. Curing a monomer material converts the monomer into polymer and fixes the polymer via the formation of covalent chemical bonds; the formed covalent chemical bonds may fix the polymer by forming chemical crosslinks with the hologram or the formed covalent chemical bonds may increase the molecular weight of the polymer such that the polymer is capable of forming physical crosslinks with the hologram.

Donor material may be diffused into a hologram by laminating together a hologram and a donor film, where a donor film comprises donor material dissolved in an inert matrix. Once the donor film and the hologram are laminated together, donor material may diffuse from the donor film into the hologram through the hologram/donor film interface. The lamination may be performed either very quickly or as part of a continuous process to make the diffusion of donor material more homogeneous across the lateral dimensions of the hologram. The lamination may be performed such that homogeneous coverage of the hologram by the donor film is achieved, which may include the intentional prevention of trapping bubbles of air between the donor film and the hologram, to ensure consistent swelling across the lateral dimensions of the hologram.

The magnitude of swelling within the equilibrated hologram depends on the thickness of the hologram, the rate of diffusion of donor material from the donor film into the hologram, and the time allowed for diffusion of donor material into the hologram. A desired amount of swelling may be established via careful control of the amount of donor material that diffuses into the hologram. Non-exclusive examples of factors that affect the initial diffusion rate include the concentration of donor material in the donor film, the molecular weight of the donor material, the concentration of donor material in the hologram, the temperature, the viscosity of the donor film, and the viscosity of the hologram. The viscosity of the hologram depends on the molecular weight and crosslink density of the photopolymer in the hologram which in turn depend on the curing conditions used during hologram fabrication. The diffusion rate may vary during swelling, for example the donor film may become depleted of donor material at the donor film/hologram interface if the donor film is sufficiently thin or viscous; the presence of donor material in the hologram may also plasticize the hologram thereby reducing the viscosity of the hologram.

Small variations in: the temperature during lamination, donor film thickness, concentration of donor material in the donor film, hologram thickness, hologram recording conditions, and hologram curing conditions may case large variations in diffusion rate, either independently or cumulatively. Large variations in diffusion rates negates the possibility of determining a single correct diffusion time necessary to achieve a desired amount of swelling, which makes large-scale production of swollen films (based on a fixed time for swelling) impractical since the wavelength shift of the resulting swollen holograms cannot be reliably controlled. Uncontrolled wavelength shifting of a hologram may produce a hologram with a playback wavelength that is higher than desired or a playback wavelength that is lower than desired.

In accordance with the present systems, devices, and methods, controlled hologram playback shifting may be achieved by laminating together a donor film and a hologram and monitoring the playback angle and/or the bandwidth of at least a portion of the hologram fringes within the hologram.

Swelling may thereby be allowed to continue long enough to achieve a desired level of playback shifting; the swelling may thereafter be stopped to prevent an undesirable amount of diffusion of donor material into the hologram. The controlled swelling of the hologram causes controlled playback shifting of the hologram which, among other applications, makes the controlled playback shifted hologram particularly well-suited for use as a transparent holographic combiner for WHUDs, as a holographic in-coupler for a light guide, as a holographic out-coupler for a light guide, and as an infrared holographic optical element (HOE). In other words, the present systems, devices, and methods describe controlled wavelength shifting of holograms.

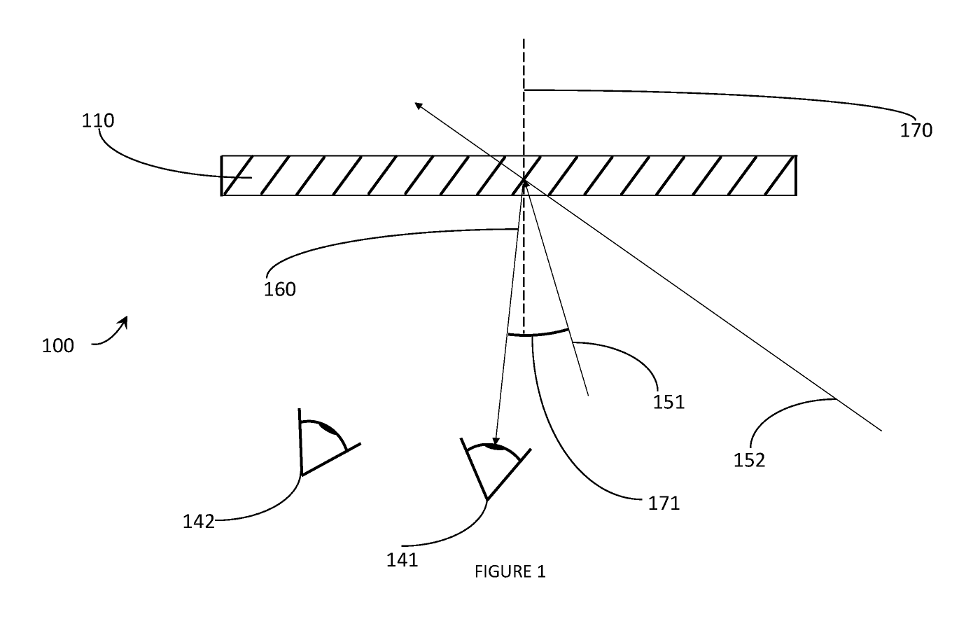

FIG. 1 is a cross-sectional view of un-swollen hologram 100. Un-swollen hologram 100 comprises set of hologram fringes 110. Un-swollen hologram 100 may be illuminated with first beam of laser light 151, and second beam of laser light 152. First beam of laser light 151 satisfies the Bragg condition for wavelength and angle for set of hologram fringes 110 and is diffracted by set of hologram fringes 110 to produce diffracted object beam 160. The angle of incidence of first beam of laser light 151 may be measured relative to normal 170. Object beam 160 may be detected by first photosensor 141.

Second beam of laser light 152 may satisfy the Bragg condition for wavelength for set of hologram fringes 110, however second beam of laser light 152 does not satisfy the Bragg condition for angle for set of hologram fringes 110 and therefore second beam of laser light 152 is not diffracted by set of hologram fringes 110; second beam of laser light 152 cannot be redirected to either of first photosensor 141 or second photosensor 142. A person of skill in the art will appreciate that, in the alternative, second beam of laser light may satisfy the Bragg condition for angle for set of hologram fringes 110 but not the Bragg condition for wavelength for set of hologram fringes 110 and be similarly incapable of diffraction by set of hologram fringes 110. If un-swollen hologram 100 is employed as a holographic combiner in a WHUD, the SLP must be positioned such that the angle of the laser light produced by the SLP matches the angle of the reference beam used to record the hologram, with the recording geometry imposing limits on that angle. If un-swollen hologram 100 is employed as a holographic in-coupler or as a holographic out-coupler, the playback angle of the hologram will be limited by the recording geometry. Un-swollen hologram 100 may only be employed as an infrared HOE if hologram 100 is recorded with an infrared laser.

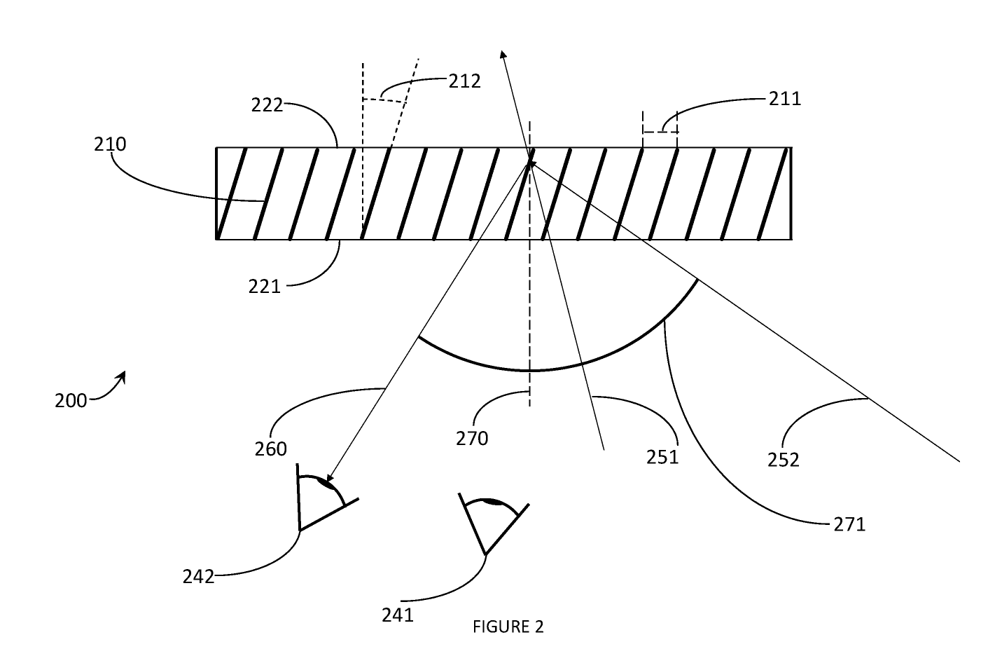

FIG. 2 is a cross-sectional view of controllably playback shifted hologram 200 in accordance with the present systems, devices, and methods. Controllably playback shifted hologram 200 comprises first set of fringes 210, first surface 221, and second surface 222. Second surface 222 is opposite first surface 221. Set of fringes 210 is disposed between first surface 221 and second surface 222. Controllably playback shifted hologram 200 may have a thickness less than 0.1 mm, which is advantageous as a hologram with a thickness less than 0.1 typically possesses sufficient playback efficiency for use as a holographic combiner or incoupler/outcoupler, and a thinner hologram has higher transparency than a thicker hologram; however controllably playback shifted hologram 200 may have a thickness up to 1 mm. Controllably playback shifted hologram 200 may be curved; if controllably playback shifted hologram 200 is curved then first surface 221 and second surface 222 are necessarily curved. A curved surface may be a cylindrically curved surface; a cylindrically curved surface is curved around an axis of curvature. The center or axis of curvature, as appropriate, of controllably playback shifted hologram 200 may be located at a distance of between 1 and 10 centimeters, between 10 and 50 cm, or between 50 and 100 cm from either first surface 221 or second surface 222.

Due to the controllable playback shifting that was previously applied to controllably playback shifted hologram 200, set of hologram fringes 210 does not have the same fringe spacing as the hologram originally recorded in controllably playback shifted hologram 200, therefore set of hologram fringes 210 has different ranges of angles and wavelengths that satisfy the Bragg condition for hologram playback. Controllably playback shifted hologram 200 may be illuminated with first beam of laser light 251 and second beam of laser light 252. First beam of laser light 251 may have satisfied the Bragg condition for wavelength and angle for set of hologram fringes 210 prior to the application of controllable playback shifting, however first beam of laser light 251 does not satisfy the Bragg condition for wavelength and angle for set of hologram fringes 210 and is not diffracted by set of hologram fringes 210. The angle of incidence of first beam of laser light 251 may be measured relative to normal 270.

Second beam of laser light 252 may not have satisfied the Bragg condition for wavelength and angle for set of hologram fringes 210 prior to the application of controllable playback shifting, however second beam of laser light 252 does satisfy the Bragg condition for wavelength and angle for set of hologram fringes 210; second beam of laser light 252 will be diffracted by set of hologram fringes 210 to produce diffracted object beam 260. Diffracted object beam 260 possesses redirection angle 271, measured as the angle between second beam of laser light 252 and diffracted object beam 260. Redirection angle 271 is measured between the diffracted beam and the incident portion of second beam of laser light 252 because controllably playback shifted hologram 200 is a reflection hologram; if controllably playback shifted hologram 200 was a transmission hologram then redirection angle 271 would be measured between diffracted object beam 260 and the portion of second beam of laser light 252 that is transmitted through controllably playback shifted hologram 200. Due to the geometry of how redirection angles are measured, redirection angles must be less than 180 degrees.

Because the angle of incidence of second laser beam 252, measured from normal 270, is not equal to the angle of incidence of first beam of laser light 251 second diffracted object beam 262 may be detected by second photosensor 242 rather than first photosensor 241. A person of skill in the art will appreciate that, in the alternative, second beam of laser light may be of a different wavelength than beam of laser light and similarly be diffracted by set of hologram fringes 210 and detected by photosensor 242.

Redirection angle 271 may be greater than 45 degrees, greater than 90 degrees, or greater than 140 degrees. A larger redirection angle is advantageous for SLP-based WHUDs as this allows the SLP to be positioned further forward in the WHUD which helps to avoid obstruction of the laser beam by the user's eyelashes. A larger redirection angle is advantageous for light guide-based WHUDS as holographic in-couplers and out-couplers with larger redirection angles allow for greater flexibility in positioning of the display relative to the projector and the eye of the user. A redirection angle greater than 45 degrees is advantageous as it allows a laser projector comprising a WHUD to be positioned closer to the holographic combiner, reducing the size of the projector assembly. A redirection angle greater than 90 degrees is advantageous as it allows a holographic incoupler for a light guide to be illuminated with light approaching an angle normal to the holographic incoupler and still redirect said light into the light guide at an angle that achieves total internal reflection. A redirection angle greater than 140 degrees is advantageous as it allows a holographic incoupler for a light guide to be illuminated with light at an oblique angle, reverse the direction of said light, and still redirect said light into the light guide at an angle that achieves total internal reflection. A person of skill in the art of holography will appreciate that the redirection angle is intrinsically limited to 180 degrees.

Controllably playback shifted hologram 200 comprises donor material. Donor material comprises material which, after diffusing into a hologram, swells the hologram fringes and shifts the playback of the hologram. Donor material may comprise polymerizable material, where polymerizable material may comprise monomer and initiator; polymerizable material may further comprise crosslinker. Monomer may comprise a mono-functional, bi-functional, or multi-functional monomer. Initiator may comprise photo-initiator, and initiator may further comprise co-initiator. Donor material may comprise the chemical reaction products of polymerizing, curing, fixing, and/or bleaching polymerizable material.

A holographic recording medium (“HRM”) comprises photosensitive material which undergoes a chemical or physical change upon exposure to light. When a HRM is exposed to a pattern of optical fringes, the photosensitive material records the pattern of optical fringes as a pattern of physical fringes. Controllably playback shifted hologram 200 comprises HRM material, where HRM material is the physical and chemical components that comprise a HRM. Non-exclusive examples of HRM material include: silver halide photographic emulsion, dichromated gelatin, photopolymer, and photorefractive material. HRM material may comprise the chemical reaction products formed by recording a hologram. HRM material may comprise the chemical reaction products formed by curing, fixing, and/or bleaching a HRM after recording a hologram in said HRM.

Set of fringes 210 possesses fringe spacing 211 that is at least approximately constant between first surface 221 and second surface 222. Fringe spacing 211 depends on the fringe spacing of the hologram originally recorded in the HRM material comprising controllably playback shifted hologram 200 and the concentration of donor material relative to the concentration of HRM material within controllably playback shifted hologram 200. Fringe spacing 211 may increase with increasing concentration of donor material relative to the concentration of HRM material within controllably playback shifted hologram 200. The concentration of donor material is at least approximately constant between first surface 221 and second surface 222. The concentration of HRM material is at least approximately constant between first surface 221 and second surface 222. Throughout this specification and the appended claims, the phrase “at least approximately constant” is defined as “varying by plus or minus 10%”. The at least approximately constant concentration of donor material and HRM material ensures that the Bragg conditions of controllably playback shifted hologram 200 is at least approximately constant. If the concentration of donor material and HRM material within controllably playback shifted hologram 200 was not at least approximately constant then the controllably playback shifted hologram 200 would not in fact possess controllably shifted playback but would instead possess a broadened bandwidth.

Set of fringes 210 possesses slant angle 212 that is at least approximately constant between first surface 221 and second surface 222. Slant angle 212 depends on the slant angle of the hologram originally recorded in the HRM material comprising controllably playback shifted hologram 200 and the concentration of donor material relative to the concentration of HRM material within controllably playback shifted hologram 200. Slant angle 212 may increase with increasing concentration of donor material relative to the concentration of HRM material within controllably playback shifted hologram 200; alternatively Slant angle 212 may decrease with increasing relative concentration of donor material.

Controllably playback shifted hologram 200 possesses an incident playback angle, wherein the incident playback angle comprises the range of angles that satisfy the Bragg condition for hologram playback of controllably playback shifted hologram 200. The incident playback angle of controllably playback shifted hologram 200 is at least approximately constant between first surface 221 and second surface 222. The incident playback angle may be greater than 45 degrees, greater than 60 degrees, or greater than 70 degrees. The incident playback angle depends on the incident playback angle of the hologram originally recorded in the HRM material comprising controllably playback shifted hologram 200 and the concentration of donor material relative to the concentration of HRM material within controllably playback shifted hologram 200. The incident playback angle may increase with increasing concentration of donor material relative to the concentration of HRM material within controllably playback shifted hologram 200. An incident playback angle greater than 45 degrees is advantageous as it allows a laser projector comprising a WHUD to be positioned closer to the holographic combiner, reducing the size of the projector assembly. A redirection angle greater than 60 degrees and/or a redirection angle greater than 70 degrees is advantageous as it allows a holographic incoupler for a light guide to be illuminated with light at an oblique angle and still redirect said light into the light guide at an angle that achieves total internal reflection. A person of skill in the art of holography will appreciate that the incident playback angle is intrinsically limited to 90 degrees; an incident playback angle greater than 90 degrees constitutes a transformation from a reflection hologram to a transmission hologram or vice versa.

Controllably playback shifted hologram 200 possesses a playback wavelength, wherein the playback wavelength comprises the range of wavelengths that satisfy the Bragg condition for hologram playback of controllably playback shifted hologram 200. The playback wavelength of controllably playback shifted hologram 200 is at least approximately constant between first surface 221 and second surface 222. The playback wavelength may be greater than 680 nanometers, greater than 690 nanometers, greater than 850 nm, or greater than 1000 nanometers. Above 680 nm, directly recording a hologram with laser light becomes difficult due to the decrease in absorbance of typical photopolymer-based holographic recording materials, therefore controllably shifting the playback wavelength above 680 nm is advantageous to alleviate this difficulty. Above 690 nm, directly recording a hologram with laser light becomes effectively impossible due to the severe decrease in absorbance of typical photopolymer-based holographic recording materials, therefore controllably shifting the playback wavelength above 690 nm is advantageous to allow access to this range of wavelengths. Achieving a greater playback wavelength is advantageous as longer wavelength holograms include infrared holograms, of which there is a general lack in the state of the art. A playback wavelength for a controllably shifted playback hologram is typically limited to no greater than four times the wavelength of the laser initially used to record the hologram; for example a hologram initially recorded with a 660 nm laser typically cannot be controllably playback shifted above 2640 nm.

The playback wavelength depends on the playback wavelength of the hologram originally recorded in the HRM material comprising controllably playback shifted hologram 200 and the concentration of donor material relative to the concentration of HRM material within controllably playback shifted hologram 200. The playback wavelength may increase with increasing concentration of donor material relative to the concentration of HRM material within controllably playback shifted hologram 200.

A person of skill in the art will appreciate that redirection angle 271 may be greater than the redirection angle of the hologram originally recorded in the HRM material comprising controllably playback shifted hologram 200. A person of skill in the art will appreciate that controllably playback shifted hologram 200 may possess a playback wavelength that is longer than the playback wavelength of the hologram originally recorded in controllably playback shifted hologram 200; a longer playback wavelength allows a hologram to be recorded in the HRM material comprising controllably playback shifted hologram 200 using a visible wavelength laser but, after application of controllable playback shifting, controllably playback shifted hologram 200 may be played back at infrared wavelengths.

Controllably playback shifted hologram 200 may comprise a wavelength-multiplexed hologram. A wavelength multiplexed hologram comprises at least two wavelength-specific holograms, wherein each wavelength-specific hologram has a respective playback wavelength; each wavelength-specific hologram may have a respective incident playback angle and a respective redirection angle. A wavelength multiplexed hologram may include a red hologram, a green hologram, and a blue hologram, which advantageously allows the hologram to be used in a full-color display (as a holographic combiner or as a holographic incoupler/outcoupler).

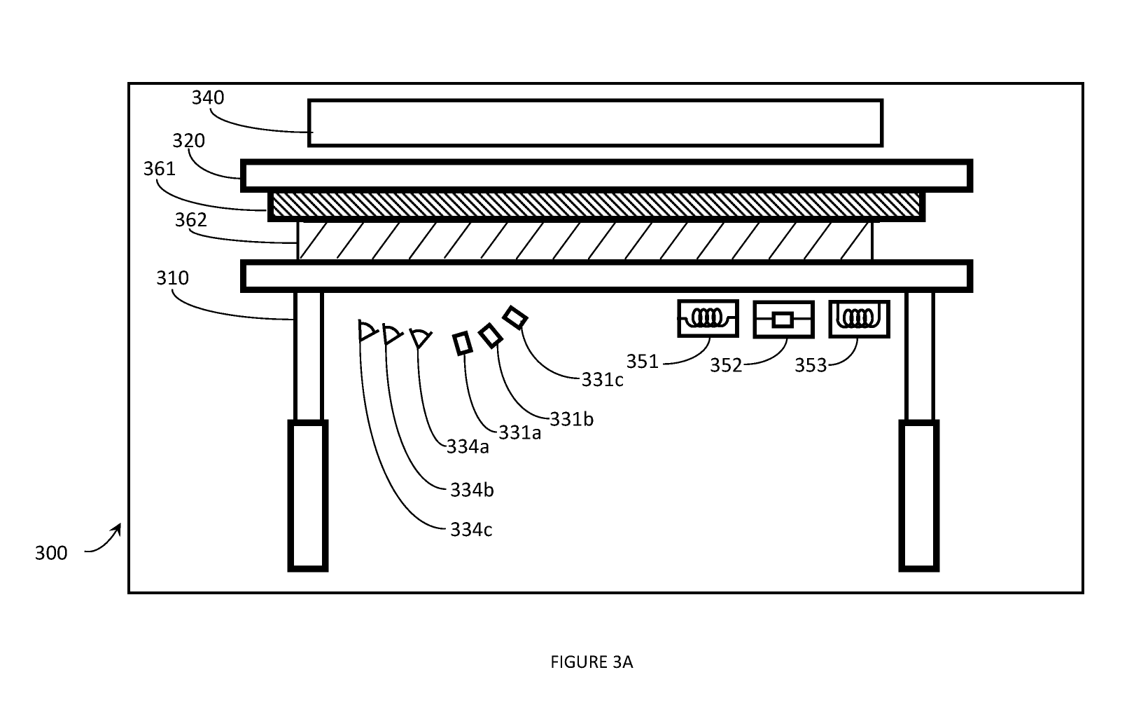

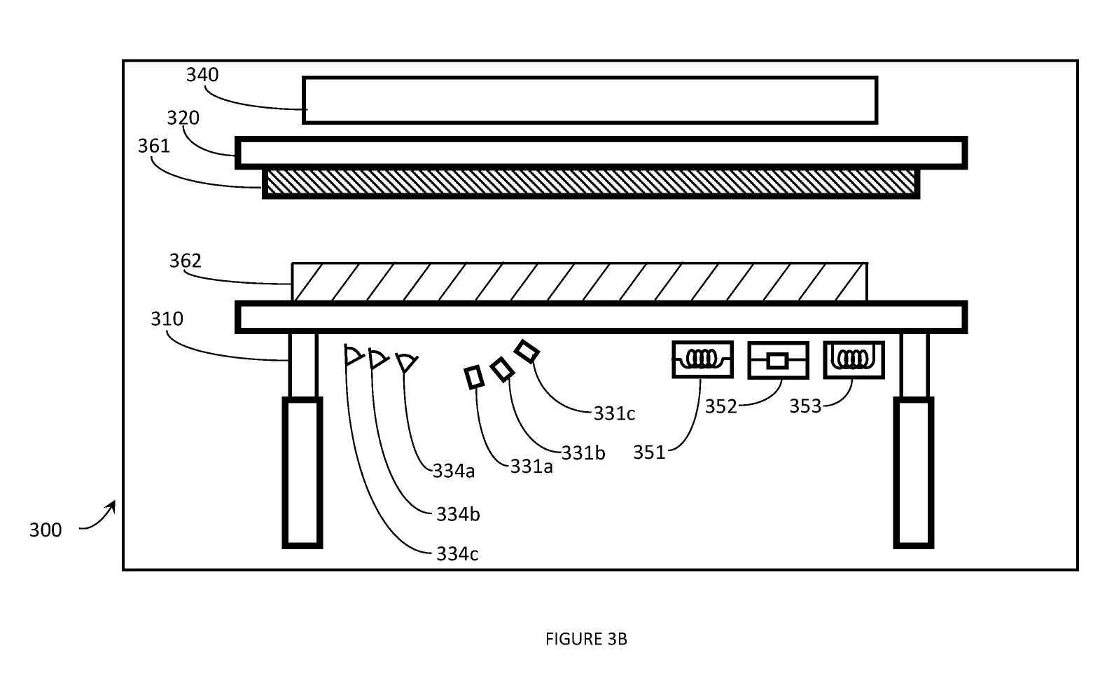

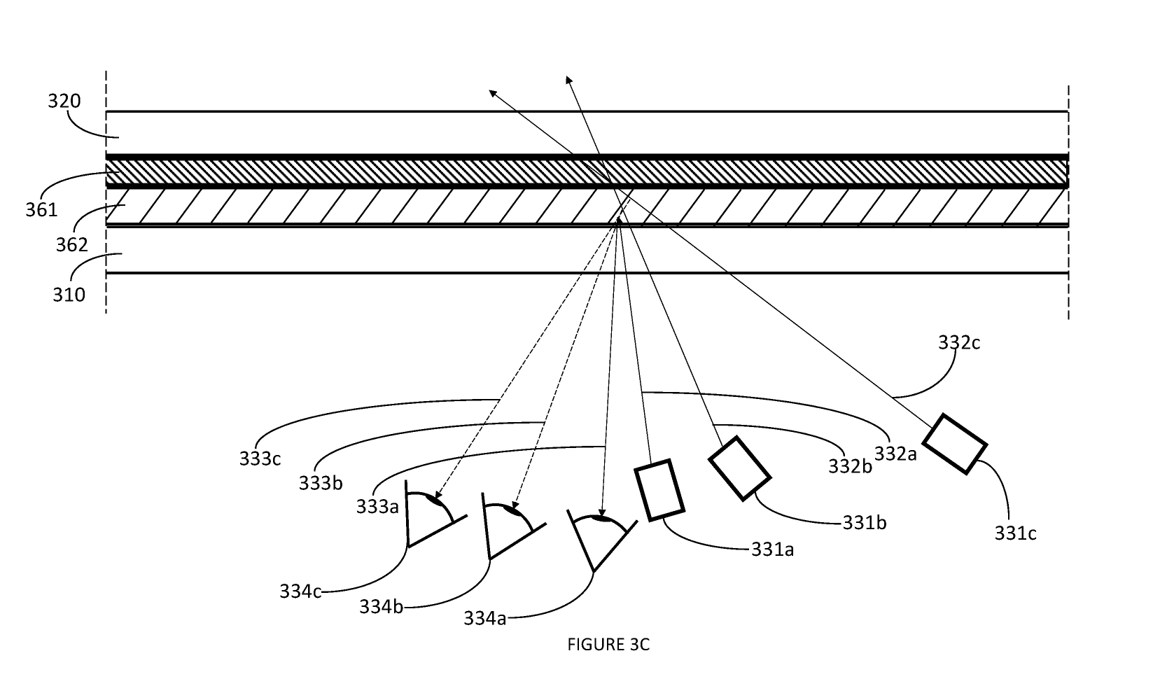

FIG. 3A is a schematic diagram of hologram controllable playback shifting apparatus 300 in accordance with the present systems, devices, and methods. Hologram controllable playback shifting apparatus 300 comprises hologram film holder 310, donor film holder 320, first light source 331a, first light sensor 334a, and controllable curing lamp 340. Hologram film holder 310 may hold (i.e. be physically coupled to) hologram film 362. Donor film holder 320 may hold (i.e. be physically coupled to) donor film 361.

Hologram film holder 310 is arranged to controllably physically couple hologram film 362 to donor film 361, where hologram film holder 310 being arranged to controllably physically couple hologram film 362 to donor film 361 includes hologram film holder 310 being arranged to maintain hologram film 362 and donor film 361 in a physically uncoupled state, physically couple hologram film 362 to donor film 361, maintain hologram film 362 and donor film 361 in a physically coupled state, and physically uncouple hologram film 362 from donor film 361. Hologram film holder 310 may comprise a moveable platform, wherein movement of hologram film holder 310 towards donor film holder 320 causes hologram film 362 (held by hologram film holder 310) to be physically coupled to donor film 361 (held by donor film holder 320). Hologram film holder 310 may comprise a pair of rollers, wherein tension may be applied to hologram film 362 by hologram film holder 310 causing hologram film 362 to be physically coupled to donor film 361. Hologram film holder 310 is transparent, where being transparent includes being transparent to light emitted by controllable curing lamp 340 and first light source 331a; being transparent may include having a sufficiently open structure that light may pass through empty space bounded by hologram film holder 310.

Donor film holder 320 is arranged to controllably physically couple donor film 631 to hologram film 362, where donor film holder 320 being arranged to controllably physically couple hologram film 362 to donor film 361 includes donor film holder 320 being arranged to maintain donor film 361 and hologram film 362 in a physically uncoupled state, physically couple donor film 361 to hologram film 362, maintain donor film 361 and hologram film 362 in a physically coupled state, and physically uncouple hologram film 362 from donor film 361. Donor film holder 320 may comprise a moveable platform, wherein movement of donor film holder 320 towards hologram film holder 310 causes donor film 361 (held by donor film holder 320) to be physically coupled to hologram film 362 (held by hologram film holder 310). Donor film holder 320 may comprise a pair of rollers, wherein tension may be applied to donor film 361 by donor film holder 320 causing donor film 361 to be physically coupled to hologram film 362.

Hologram film 362 comprises hologram fringes, wherein the spacing of the hologram fringes is consistent with the fringe spacing of the hologram fringes recorded in the hologram through the depth of hologram film 362. Throughout this specification and the appended claims the term “depth” refers to a distance in the z-direction, where the z direction is normal to the surface of the plane, cylinder, or sphere of the hologram film (for planar, cylindrical, and spherical holograms, respectively). Hologram film 362 may include a wavelength multiplexed hologram; a wavelength multiplexed hologram may include a red hologram, a green hologram, and a blue hologram. A wavelength multiplexed hologram may include a UV hologram.

Donor film 361 comprises donor material and an inert matrix. Donor material comprises material which, after diffusing into a hologram, swells the hologram fringes and shifts the playback of the hologram. Donor material may comprise polymerizable material, where polymerizable material may comprise monomer and initiator; polymerizable material may further comprise crosslinker. Monomer may comprise a mono-functional, bi-functional, or multi-functional monomer. Initiator may comprise photo-initiator, and initiator may further comprise co-initiator. Donor material may comprise the chemical reaction products of polymerizing, curing, fixing, and/or bleaching polymerizable material. Donor film 320 may comprise a holographic recording medium (HRM).

First light source 331a generates first beam of light 332a. First light source 331a may comprise a white light source (e.g. a tungsten filament, halogen lamp, etc.), a monochromatic light source, or a laser light source. A non-exclusive example of a monochromatic light source is an LED light source. First beam of light 332a may comprise coherent light; first beam of light 332a may comprise laser light. First light source 331a may comprise a multi-wavelength light source; where a multi-wavelength light source produces N beams of light and each of the N beams of light possesses a respective one of N wavelengths. Multi-wavelength light sources allow simultaneous illumination of a hologram with multiple wavelengths of light, which is advantageous for measuring the playback shift of wavelength-multiplexed holograms (if the N beams of light possess wavelengths corresponding to each of the wavelength-specific holograms comprising the wavelength-multiplexed hologram). A multi-wavelength light source may be employed to measure the playback shift of a monochromatic hologram (or a single wavelength-specific hologram comprising a wavelength multiplexed hologram), where a shift in playback wavelength is used to determine the extent of playback shifting.

First light source 331a is positioned and oriented to illuminate at least a portion of hologram film 362 with first beam of light 332a when hologram film 362 is held by hologram film holder 310; illumination of hologram film 362 with first beam of light 332a may occur when hologram film 362 is controllably physically coupled to donor film 361 or vice versa. Illumination of hologram film 362 with first beam of light 332a may cause first beam of light 332a to be diffracted by hologram film 362 to produce first diffracted light signal 333a if first beam of light 332a satisfies the Bragg conditions for wavelength and angle for hologram film 362.

First light sensor 334a is positioned and oriented to measure the intensity of playback light emanating from hologram film 362 when hologram film 362 is held by hologram film holder 310. The angle between the first light source and the first light sensor may be at least90 degrees, at least 110 degrees, or at least 135 degrees. In other words, first light sensor 334a is positioned and oriented at an angle relative to first beam of light 332a equal to a first redirection angle of at least 90 degrees, at least 110 degrees, or at least 135 degrees. First light sensor 334a may comprise a single-wavelength light sensor, which is advantageous when a multi-wavelength light source is used as individual wavelength signals may be isolated.

When donor film 361 and hologram film 362 are held in a physically uncoupled state, donor material cannot diffuse from donor film 361 into hologram film 362. When donor film 361 and hologram film 362 are held in a physically coupled state, donor material may diffuse from donor film 361 into hologram film 362 causing hologram film 362 to swell and shifting the playback angle of hologram film 362. When sufficient playback shifting has occurred, the playback angle of hologram film 362 will be equal to the redirection angle of first light sensor 334a and the intensity of playback light measured by light sensor 334a will increase. A person of skill in the art will appreciate that changes in playback wavelength may be similarly employed to monitor the playback shift of hologram film 362.

In response to an increase in light measured by light sensor 334a, hologram film holder 310 and/or donor film holder 320 may physically uncouple hologram film 362 from donor film 361. Controllable curing lamp 340 may be activated to cure and fix the donor material within hologram film 362. Curing the donor material causes the donor material to harden. Fixing the donor material chemically links the donor material to hologram film 362. Each of curing and fixing the swelling reduces the ability of the donor material to diffuse. Curing and fixing the donor material ensures that the swelling of hologram fringes is maintained at the desired level. Controllable curing lamp 340 produces light of a wavelength that cures the donor material, where the range of wavelengths of light emitted by controllable curing lamp 340 does excludes the range of wavelengths of light produced by first light source 331a.

A person of skill in the art will appreciate that, depending on the thickness of hologram film 362, a gradient of swelling may be initially established within hologram film 362 when donor film 320 is physically coupled to hologram film 362. If a swelling gradient is established, both a playback shift and an increased bandwidth may be observed within hologram film 362. An increase in bandwidth of hologram film 362 will also affect the intensity of first diffracted light signal 333a. The desired level of playback shift may be correlated to a particular increase of bandwidth, thus once this increase of bandwidth increase has been achieved donor film 320 may be physically de-coupled from hologram film 362 to prevent further diffusion of donor material into hologram film 362. Diffusion within hologram film 362 will then disperse the gradient of swelling to produce an equilibrated hologram with shifted playback and no significant increase in bandwidth; controllable curing lamp 340 may then be activated to fix the hologram. Donor film 361 may then be physically de-coupled from hologram film 362 if this has not already occurred, where hologram film 362 now comprises a hologram with controllably shifted playback.

Hologram controllable playback shifting apparatus 300 may further comprise a second light source 331b. Hologram controllable playback shifting apparatus 300 may further comprise a second light sensor 334b. Second light source 334b generates second beam of light 332b. Second beam of light 332b impinges on hologram film 362 at an angle such that, initially, hologram film 362 cannot diffract second beam of light 332b. Third light source 334c generates third beam of light 332c. Third beam of light 332c impinges on hologram film 362 at an angle such that, initially, hologram film 362 cannot diffract second beam of laser light 363. A person of skill in the art will appreciate that second beam of light 332b may be of a wavelength such that second beam of light 332b may not be diffracted by hologram film 362. A person of skill in the art will appreciate that third beam of light 332c may be of a wavelength such that second beam of laser light 363 may not be diffracted by hologram film 362.

The controllable playback shifting of hologram film 362 caused by diffusion of donor material into hologram film 362 may shift the playback of hologram 362 to allow hologram film 362 to diffract second beam of light 332b to produce second diffracted light signal 333b. The intensity of second diffracted light signal 333b may be detected by second light sensor 334b. Second light sensor 334b is positioned and oriented at an angle relative to second beam of light 332b equal to a second redirection angle of at least 90 degrees.

The controllable playback shifting of hologram film 362 caused by diffusion of donor material into hologram film 362 may shift the playback of hologram 362 to allow hologram film 362 to diffract third beam of light 332c to produce third diffracted light signal 333c. The intensity of third diffracted light signal 333c may be detected by third light sensor 343. Third light sensor 334c is positioned and oriented at an angle relative to third beam of light 332c equal to a third redirection angle of at least 90 degrees.

The effect of diffusion of donor material into hologram film 362 on the intensity of light measured by second light sensor 334b may substantively similar to the effect of diffusion of donor material into hologram film 362 on the intensity of light measured by first light sensor 334a. The effect of diffusion of donor material into hologram film 362 on the intensity of light measured by third light sensor 334c may substantively similar to the effect of controllable playback shifting on the intensities of light measured by first light sensor 334a.

Comparing the differences between the intensities of light measured by first light sensor 334a, second light sensor 334b, and third light sensor 334c (collectively: set of light sensors 334) allows greater control over playback shifting. Controllable playback shifting will cause each of first light signal 332a, second light signal 332b, and third light signal 332c, (collectively: set of light signals 332) to be diffracted by hologram film 362 when different amounts of playback shifting have been achieved; comparison of the intensities of light measured by set of light sensors 334 over time allows the rate of playback shifting to be determined. The rate of playback shifting may vary with the temperature of donor film 361, the temperature of hologram film 362, and the material properties (chemical composition, thickness, viscosity) of each of donor film 361 and hologram film 362.

Comparing the differences between the intensities of light measured by set of light sensors 334 may allow for variation in the amount of playback shifting achieved by controllable playback shifting apparatus 300. If a relatively small amount of playback shifting is desired, controllable curing lamp 340 may be activated immediately upon an observed increase in the intensity of second diffracted light signal 333b as detected by second light sensor 334b. If a relatively large amount of playback shifting is desired, the activation of controllable curing lamp 340 may be delayed until after an increase in the intensity of third diffracted light signal 333c is detected by third light sensor 334c. Greater variety in available levels of playback shifting may be obtained through the inclusion of additional laser light sources and light sensors in hologram controllable playback shifting apparatus 300.

First light source 331a, second light source 331b, and third light source 331c (collectively: set of light sources 331) may all produce light with the same wavelength. Set of light sources 331 may be individual continuous wave lasers, pulsed lasers, diode lasers, or other laser light sources. Set of light sources 331 may each redirect a portion of a primary laser beam provided by an additional laser light source. The wavelength of laser light produced by each light source comprising set of light sources 331 may be of a wavelength that is not absorbed by the donor material within donor film 320. The wavelength of laser light produced by each light source comprising set of light sources 331 may advantageously be of the same wavelength as one of the light sources used to record the hologram. The wavelength of laser light produced by each light source comprising set of light sources 331 may be an infrared wavelength of light.

Hologram controllable playback shifting apparatus 300 may comprise a cylindrical roller compatible with roll-to-roll printing methods, wherein roll-to-roll printing methods include roll-to-roll hologram recording. Hologram controllable playback shifting apparatus 300 may further comprise controllable heat source 351. Controllable heat source 351 is located sufficiently proximate hologram film holder 310 to increase the temperature of at least hologram film holder 310; controllable heat source 351 may also increase the temperature of hologram film 362, donor film 361, and/or donor film holder 320. Controllable heat source 351 provides controllable heating; in other words the magnitude of the increase in temperature of at least hologram film holder 310 is controllable. Controllable heating may be achieved by switching controllable heat source 351 between an ON and an OFF state. Controllable heating may be achieved by controlling the amount of heat generated by controllable heat source 351, e.g. the amount of thermal energy (in watts) delivered by controllable heat source 351. A person of skill in the art will appreciate that, while the amount of thermal energy delivered by controllable heat source 351 may be expressed in watts, this does not therefore require that controllable heat source 351 comprise an electric heater. Increasing the temperature of hologram film 362 and/or donor film 320 may be advantageous, since the rate of diffusion of donor material typically increases with increasing temperature. Non-exclusive examples of controllable heat sources include electric heaters, heat pumps, hot water baths, hot air sources, inductive heaters, and radiative heaters. Hologram controllable playback shifting apparatus 300 may further comprise controllable cold source 353. Controllable cold source 353 is located sufficiently proximate hologram film holder 310 to decrease the temperature of at least hologram film holder 310; controllable cold source 353 may also decrease the temperature of hologram film 362, donor film 361, and/or donor film holder 320. Controllable cold source 353 provides controllable cooling; in other words the magnitude of the decrease in temperature of at least hologram film holder 310 is controllable. Controllable cooling may be achieved by switching controllable cold source 353 between an ON and an OFF state. Controllable cooling may be achieved by controlling the amount of heat energy removed by controllable heat source 351, e.g., the amount of thermal energy (in watts) removed by controllable heat source 351. Decreasing the temperature of hologram film 362 and/or donor film 320 may be advantageous, since the rate of diffusion of donor material typically decreases with increasing temperature. Non-exclusive examples of controllable heat sources include heat pumps, compressed air sources, chilled gas sources, and liquid nitrogen sprayers.

FIG. 3A depicts hologram controllable playback shifting apparatus 300 maintaining donor film 361 and hologram film 362 in a physically coupled state. FIG. 3B depicts hologram controllable playback shifting apparatus 300 maintaining donor film 361 and hologram film 362 in a physically uncoupled state. FIG. 3C is a cross-sectional view of a portion of hologram controllable playback shifting apparatus 300 depicting the arrangement of set of light sources 331 and set of light sensors 334 relative to hologram film holder 310, donor film holder 320, hologram film 362 and donor film 361. First light source 331a produces first beam of light 331a which is diffracted by hologram film 362 to produce first diffracted light beam 333a; the intensity of first diffracted light beam 333a is then measured by first light sensor 334a. Second light source 331b produces second beam of light 332b. Second light sensor 334b is arranged to measure the intensity of second diffracted light beam 333b, where second diffracted light beam 333b is only produced when sufficient playback shifting has occurred to allow hologram film 362 to diffract second beam of light 332b. Third light source 331c produces third beam of light 332c. Third light sensor 334c is arranged to measure the intensity of third diffracted light beam 333c, where third diffracted light beam 333c is only produced when sufficient playback shifting has occurred to allow hologram film 362 to diffract third beam of light 332c.

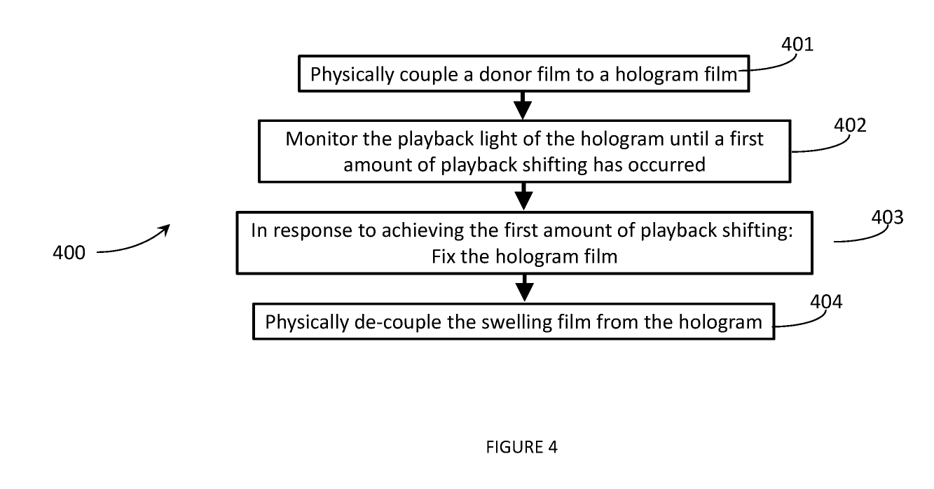

FIG. 4 is a flow-diagram showing a method 400 of controllable playback shifting of a hologram in accordance with the present systems, devices, and methods. The hologram may be substantially similar to controllable playback shifted hologram 200 and generally includes shifting the playback of a hologram in a controllable manner. Method 400 includes four acts 401, 402, 403, and 404, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments. Method 400 may include employing hologram controllable playback shifting apparatus 300.

At 401, a donor film is physically coupled to the hologram film. The hologram film comprises a hologram recorded in a holographic recording medium (“HRM”). The hologram comprises hologram fringes. The hologram possesses a playback wavelength, an incident playback angle, and a playback angle.

The donor film may be physically coupled to the hologram film by pressing the donor film and the hologram film together. The donor film may be physically coupled to the hologram film with an adhesive (e.g. pressure-sensitive adhesive, low-temperature optically clear adhesive); alternatively the donor film may possess sufficient adhesive properties (e.g. tackiness) that an additional adhesive is not required to ensure physical coupling between the donor film and the hologram film. The donor film may comprise donor material and an inert matrix. Donor material comprises material which, after diffusing into a hologram, swells the hologram fringes and shifts the playback of the hologram. Donor material may comprise curable donor material. Donor material may comprise polymerizable material, where polymerizable material may comprise monomer and initiator; polymerizable material may further comprise crosslinker. Non-exclusive examples of monomer include methyl methacrylate, ethylene glycol dimethacrylate and trimethylpropane triacrylate. Donor material may comprise photosensitive material, where photosensitive material may be photopolymerizable. Photosensitive material may be similar to material comprising the HRM in which the hologram is recorded. The donor material may advantageously comprise material that is insensitive to at least a portion of the wavelength(s) of light employed to monitor playback shifting. The hologram film may comprise a first photopolymer film and the donor film may comprise a second photopolymer film. Employing photopolymer film as the donor film and the hologram film is advantageous since photopolymer may readily be converted into hologram film (for example, by recording a hologram in the photopolymer film) and the donor material that diffuses from the donor film into the hologram film will be highly compatible with the hologram film if the first photopolymer film and the second photopolymer film comprise photopolymer films with identical chemical compositions.

Physically coupling the donor film to the hologram film includes forming an interface between the donor film and the hologram film, wherein formation of said interface causes donor material to diffuse from the donor film into the hologram film. The concentration of donor material within the donor film is initially higher than the concentration of donor material within the hologram film, therefore the chemical potential of the donor material is higher in the donor film relative to the hologram film. Once the donor film is physically coupled to the hologram film, the higher chemical potential of the donor material within the donor film causes the donor material to diffuse from the donor film into the hologram film. The movement of donor material into the hologram film may be actively driven, for example through the application of an electric field (for donor material comprising electrically charged donor material) where the applied electric field causes electrically charged donor material to move; movement of donor material may similarly be actively driven through the application of a magnetic field (for donor material comprising magnetically active donor material).

The donor material must cross the interface between the donor film and the hologram film, thus donor material must enter the hologram film at the donor film/hologram film interface. The concentration of donor material, and therefore the chemical potential of the donor material, within the hologram film will be highest at a depth nearest to the donor film/hologram film interface and will decrease as the depth from the donor film/hologram film interface increases. The donor material will then diffuse from the donor film/hologram film interface towards the opposite side of the hologram film.

Diffusing donor material from the donor film into the hologram film requires some amount of time, with a greater amount of time allowing a greater amount of diffusion from the donor film into the hologram film. Given sufficient time, the chemical potential (and therefore the concentration) of donor material within the hologram film will become equal to the chemical potential of donor material within the donor film and diffusion will cease. Diffusing donor material from the donor film/hologram film interface towards the opposite side of the hologram film requires some amount of time, with a greater amount of time allowing a greater amount of diffusion from the donor film/hologram film interface towards the opposite side of the hologram film. Given sufficient time, the chemical potential (and therefore the concentration) of donor material at the donor film/hologram film interface will become equal to the chemical potential of donor material at the opposite side of the hologram film and diffusion will cease.

The presence of donor material within the hologram film causes the fringes within the hologram film to swell, and swollen fringes play back at different angles and/or wavelengths than un-swollen fringes. When the concentration of donor material is at least approximately constant through the thickness of the hologram film the playback angle and the playback wavelength of the hologram film are at least approximately constant through the thickness of the hologram film i.e. the playback of the hologram is shifted. The amount of swelling of the fringes relative to the original spacing of the un-swollen fringes determines the amount of playback shifting that has occurred, which in turn depends on the amount of donor material that diffuses from the donor film into the hologram film.

At 402, the playback of the hologram film is monitored. Monitoring the playback of the hologram film may include monitoring the playback angle of the hologram film, monitoring the playback wavelength of the hologram film, and monitoring the bandwidth of the hologram film. Monitoring the bandwidth of the hologram film may include monitoring the spectral bandwidth of the hologram film and monitoring the angular bandwidth of the hologram film. Monitoring the playback of the hologram film may include monitoring the playback of the hologram film continuously or at discrete moments in time.

Monitoring the playback of the hologram film includes illuminating the hologram film with light; illuminating the hologram film with light may include illuminating the hologram film with a beam of monochromatic light. Illuminating the hologram film with light may include illuminating the hologram film with laser light; the laser light may comprise light of a wavelength which may not be absorbed by the donor material. Illuminating the hologram film with light may include illuminating the hologram film with a beam of light where the beam of light possesses at least one wavelength at least one angle. Monitoring the playback of the hologram film may include monitoring the light diffracted by the hologram film; monitoring the light diffracted by the hologram film may include monitoring the light diffracted by the hologram film at at least one angle and monitoring the light diffracted by the hologram film at at least one wavelength.

As the donor material diffuses from the donor film into the hologram film the playback angle of the hologram film may increase or decrease. As the donor material diffuses from the donor film into the hologram film the playback wavelength of the hologram film may increase or decrease. The magnitude of the increase or decrease in playback angle and/or wavelength comprises an amount of playback shifting. Monitoring the playback light of the hologram film allows the amount of playback shifting of the hologram film that has been achieved to be measured, where monitoring the playback light of the hologram may include monitoring the playback wavelength and/or the playback angle of the hologram. Monitoring the playback light of the hologram may include monitoring the playback light of the hologram until a first amount of playback shifting has occurred. The first amount of playback shifting may comprise a first increase (or decrease) in playback wavelength; the first amount of playback shifting may comprise a first increase (or decrease) in playback angle. Monitoring the playback light of the hologram may include monitoring the playback light of the hologram until at least one additional amount of playback shifting has occurred.

Monitoring a playback light of the hologram of the hologram film until a first amount of playback shifting has occurred may include monitoring a playback light of the hologram of the hologram film until the hologram of the hologram film possesses a redirection angle of at least 45 degrees, at least 90 degrees, or at least than 140 degrees. Monitoring a playback light of the hologram of the hologram film until a first amount of playback shifting has occurred may include monitoring a playback light of the hologram of the hologram film until the hologram of the hologram film possesses a playback wavelength of greater than 680 nanometers, greater than 690 nanometers, greater than 850 nm, or greater than 1000 nanometers.

Monitoring the playback light of the hologram of the hologram film may include illuminating the hologram film with infrared light and measuring an intensity of the infrared light diffracted by the hologram. Recording a hologram with infrared light is typically difficult due to the insensitivity of typical holographic recording media to infrared light. Recording a hologram with visible light is within the skill of a person of skill in the art of holography. A hologram may be recorded with visible light, for example red light, and the playback wavelength of the recorded hologram may be controllably shifted until the hologram plays back at an infrared wavelength. Monitoring the infrared playback light of the hologram allows controllable playback shifting of a hologram to controllably shift a visible hologram into the infrared. Monitoring the playback light of the hologram of the hologram film may include illuminating the hologram film with light of a wavelength to which the donor material is insensitive, which ensures that monitoring the playback light of the hologram does not cause fixing of the donor material prior to achieving a first amount of playback shifting. A non-exclusive example of illuminating the hologram film with light of a wavelength to which the donor material is insensitive is illuminating a donor material which is sensitive to visible wavelengths of light with infrared light.

The hologram film may comprise at least one plane-wave sub-hologram, and monitoring the playback of the hologram of the hologram film may include monitoring the playback light of the at least one plane-wave sub-hologram. A plane-wave sub-hologram is a hologram recorded into the hologram film, where the light used to record the plane-wave sub-hologram comprised collimated (i.e., plane-wave) light. The plane wave sub-hologram may advantageously be located in a portion of the hologram film that is outside the area of the hologram film containing a recorded HOE; in other words the hologram film comprises a primary hologram and at least one plane-wave sub-holograms. The primary hologram is the hologram intended for use in, for example, a transparent holographic combiner. The plane-wave sub-hologram may advantageously be removed from the hologram film after controllable playback shifting, for example by cutting, grinding, or otherwise removing the portion of the hologram film containing the at least one plane-wave sub-hologram. Plane wave holograms are advantageous as they do not require careful alignment in order to accurately monitor their playback light during controllable playback shifting. The primary hologram within the hologram film may comprise a spherical-wave hologram, which is advantageous as it allows the hologram to focus (or defocus) laser light to (or away from) a focal point. However, in order to accurately monitor the playback light of a spherical-wave hologram during controllable playback shifting, the exact center point of the spherical-wave hologram must be illuminated by the beam of laser light. If the exact center of the spherical-wave hologram is not illuminated, the playback of the spherical-wave hologram will depend on the distance between the illuminated spot and the center of the spherical-wave hologram. Careful alignment of the hologram is difficult, time-consuming, and subject to non-trivial amounts of error. The controllable playback shifting of the plane-wave sub-hologram may be employed to report on the controllable playback shifting of the primary hologram; in other words the playback shifting of the primary hologram may be monitored by monitoring the playback shifting of the plane-wave sub-hologram. The use of more than one plane-wave sub-hologram, and the monitoring of their playback shifting, allows the uniformity of bandwidth broadening to be determined across the area of the hologram film.

At 403, in response to achieving the first amount of playback shifting, the hologram film is fixed. Fixing the hologram film may include curing the hologram film; curing the hologram film may include fixing the donor material within the hologram film. Fixing the hologram film may include bleaching the hologram film; bleaching the hologram may include bleaching the donor material within the hologram film. Bleaching the hologram film causes the hologram film to become transparent; bleaching the donor material causes the donor material to become transparent. Curing the hologram film hardens the hologram film; curing the donor material within the hologram film hardens the donor material within the hologram film; hardening the hologram film and/or the donor material within the hologram film at least approximately stops diffusion of the donor material within the hologram film. Curing the donor material may include photopolymerizing the donor material;

photopolymerizing the donor material increases the molecular weight of the donor material and thereby at least approximately stops diffusion of the donor material. Photopolymerizing the donor material may include exposing the donor material to visible light and exposing the donor material to UV light.

Fixing the hologram may include fixing the donor film; fixing the donor film may include fixing the donor material within the donor film. Fixing the donor film may include curing the donor film and/or the donor material within the donor film. Donor material cannot diffuse out of the fixed donor film into the hologram film.

The combination of diffusing donor material into the hologram film, monitoring the playback of the hologram film until a first amount of bandwidth broadening has been achieved, and then fixing the hologram film in accordance with the present systems, designs, and methods, allows the diffusion of donor material into the hologram film to be controllable. Since playback shifting depends directly on the diffusion of donor material, the present systems, designs, and methods allow for playback shifting to be controllable.

At 404, the donor film is physically de-coupled from the hologram film. If physically de-coupling the donor film from the hologram film occurs prior to fixing the hologram film, physically de-coupling the donor film from the hologram film halts diffusion of donor material into the hologram film. The donor film may be physically de-coupled from the hologram film once a first amount of bandwidth broadening has been achieved as determined by monitoring the playback of the hologram film via act 403.

Physically de-coupling the donor film from the hologram film may occur subsequent to fixing the hologram film, in which case physically de-coupling the donor film from the hologram film does not affect diffusion of donor material from the donor film into the hologram film.

Method 400 may further comprise equilibrating the hologram film. Equilibrating the hologram film includes equilibrating the donor material within the hologram film. Equilibrating the hologram film includes causing diffusion of donor material within the hologram film absent diffusion of donor material from the donor film into the hologram film. Equilibrating the hologram film may include holding the hologram film in a state that allows diffusion of donor material within the hologram film but prevents donor material from diffusing from the donor film into the hologram film; a non-exclusive example of said state is holding the hologram film in a state where the hologram film is physically decoupled from the donor film. Equilibrating the hologram film may include holding the hologram film at a temperature that allows diffusion of donor material within the hologram film. Diffusion of donor material within the hologram film disperses any gradient of donor material within the hologram film, causing the fringe spacing of the hologram film to be at least approximately constant through the thickness of the hologram film.

When the donor film is physically coupled to the hologram film, diffusion of donor material into the hologram film may cause bandwidth broadening to occur, where the bandwidth broadening comprises a particular type of playback shifting. Bandwidth broadening typically occurs when the hologram film is thick relative to the rate of diffusion, for example when the hologram film is thick enough that the time required for a given amount of donor material to diffuse through the entire thickness of the hologram film is at least approximately equal to (or greater than) the time required for said amount of donor material to diffuse from the donor film into the hologram film.

Monitoring the playback light of the hologram may include monitoring the playback light of the hologram of the hologram film until an additional amount of playback shifting has occurred. The additional amount of playback shifting may comprise bandwidth broadening. Act 404 may include physically de-coupling the donor film from the hologram film in response to achieving the additional amount of playback shifting; physically de-coupling the donor film from the hologram film in response to achieving the additional amount of playback shifting allows equilibration to occur. Equilibration then causes the first amount of playback shifting to occur.

The hologram in the hologram film may comprise a wavelength-multiplexed hologram, wherein a wavelength-multiplexed hologram film comprises at least two wavelength-specific holograms. Each wavelength specific hologram film has a respective wavelength bandwidth and center wavelength. Each wavelength-specific hologram is therefore responsive to a respective range of wavelengths. The playback light of each wavelength-specific hologram film may be monitored independently. Monitoring the playback light of the hologram of the hologram film until a first amount of playback shifting has occurred may include monitoring the playback light of each wavelength-specific hologram comprising the hologram film until a respective first amount of playback shifting has occurred for each wavelength specific hologram comprising the hologram film. In the alternative, monitoring the playback light of the hologram of the hologram film until a first amount of playback shifting has occurred may include monitoring the playback light of only one wavelength-specific hologram comprising the hologram film until a respective first amount of playback shifting has occurred, where the playback shifting of the monitored wavelength-specific hologram reports on the playback shifting of the other wavelength-specific holograms.

A person of skill in the art will appreciate that the playback shifting of a hologram may be expressed in units of distance (e.g., nm) or in units of energy (e.g., cm⁻¹), and that values expressed in units of distance vary inversely with values expressed in energy. The first amount of playback shifting for each wavelength-specific hologram may comprise a set of amounts of playback shifting, with the set of amounts of playback shifting comprising a respective amount of playback shifting for each wavelength-specific hologram.

Method 400 may further comprise physically coupling an additional donor film to the hologram film to cause a second amount of donor material to diffuse from the donor film into the hologram film, monitoring the playback light of the hologram of the hologram film until a second amount of playback shifting has occurred, in response to achieving the second amount of playback shifting: fixing the second amount of donor material, and physically de-coupling the additional donor film from the hologram film. The process of controllable playback shifting may be performed sequentially, where each round of controllable playback shifting further shifts the playback of a previously controllably playback shifted hologram film. Each round of controllable playback shifting further shifts the playback of the hologram film, which may include an increase in the playback wavelength of the hologram film and/or an increase in the redirection angle of the hologram film.

Method 400 may further comprise recording a hologram in a holographic recording medium (“HRM”). Recording a hologram in a HRM may include recording a wavelength-multiplexed hologram. Recording a wavelength-multiplexed hologram may include recording a red hologram, a green hologram, and a blue hologram. Recording a wavelength-multiplexed hologram may include recording a UV hologram. Recording a hologram in a HRM may include recording an angle-multiplexed hologram.

Recording a hologram in a HRM may include mounting the HRM on a recording substrate; illuminating the HRM with laser light; dis-mounting the HRM from the recording substrate; and pre-fixing the HRM. A recording substrate comprises an inflexible transparent material that defines the shape of the HRM during recording. Typical recording substrates may be flat and planar. Typical recording substrate materials include glass and polycarbonate. Pre-fixing the HRM renders the HRM insensitive to light; further hologram recording is not possible in a pre-fixed HRM. Illuminating the HRM with laser light may include illuminating the HRM with at least one object laser beam and illuminating the HRM with at least one reference laser beam.

Method 400 may further comprise controllable heating at least one of: the hologram film and the donor film to increase the temperature of at least one of: the hologram film and the donor film. Controllably heating at least one of: the hologram film and the donor film may be achieved with a controllable heat source. Non-exclusive examples of controllable heat sources include: electric heating elements, heat pumps, hot water baths, hot air sources, inductive heaters, and radiative heaters. Method 400 may further comprise controllable cooling at least one of: the hologram film and the donor film to decrease the temperature of at least one of: the hologram film and the donor film. Controllably cooling at least one of: the hologram film and the donor film may be achieved with a cold source. Non-exclusive examples of cold sources include: heat pumps, compressed gas outlet nozzles, chilled gas sources, and liquid nitrogen sprayers. Method 400 may further comprise monitoring the temperature at least one of: the hologram film and the donor film.

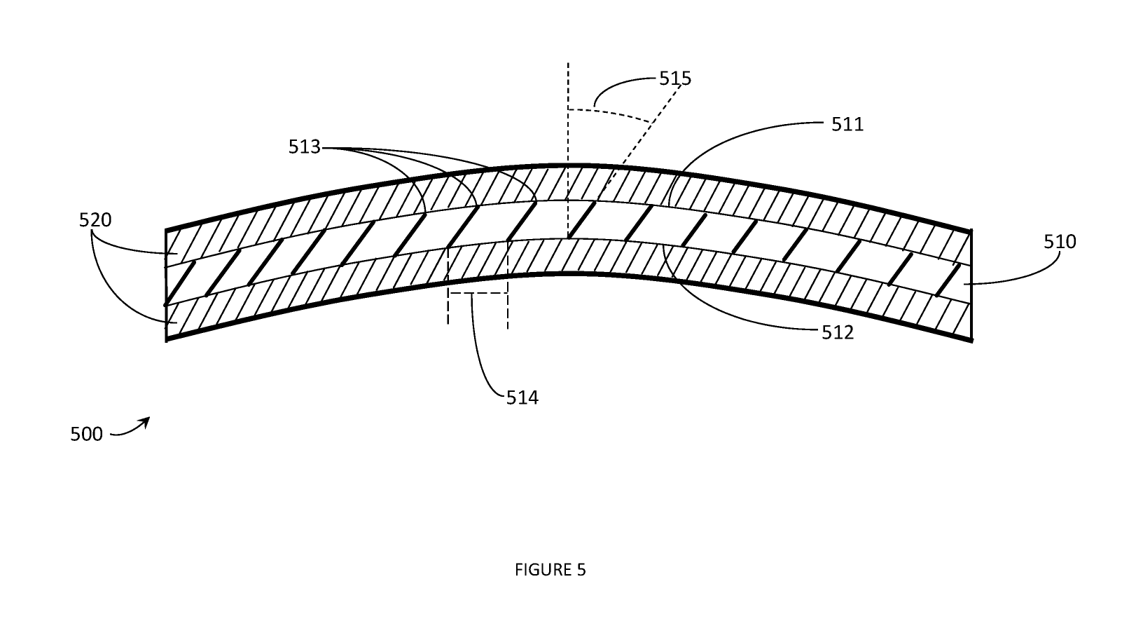

FIG. 5 is a cross-sectional view of an exemplary eyeglass lens 500 with an embedded controllably playback shifted hologram 510 suitable for use in a WHUD in accordance with the present systems, devices, and methods. Eyeglass lens 500 with an embedded controllably playback shifted hologram 510 comprises controllably playback shifted hologram 510 and lens assembly 520. Controllably playback shifted hologram 510 may be substantively similar to controllably playback shifted hologram 200. Controllably playback shifted hologram 510 is embedded within an internal volume of lens assembly 520. Controllably playback shifted hologram 510 may be physically coupled to lens assembly 520 with a low-temperature optically clear adhesive (LT-OCA).

Controllably playback shifted hologram 510 comprises set of fringes 513, first surface 511, and second surface 512. Second surface 512 is opposite first surface 511. Set of fringes 513 is disposed between first surface 511 and second surface 512. Controllably playback shifted hologram 510 may have a thickness less than 0.1 mm; in the alternative, controllably playback shifted hologram 510 may have a thickness up to 1 mm. Controllably playback shifted hologram 510 may be curved; if controllably playback shifted hologram 510 is curved then first surface 511 and second surface 512 are necessarily curved. The center or axis of curvature, as appropriate, of controllably playback shifted hologram 510 may be located at a distance of between 1 and 10 centimeters, between 10 and 50 cm, or between 50 and 100 cm from either first surface 511 or second surface 512.

Due to the controllable playback shifting that was previously applied to controllably playback shifted hologram 510, set of hologram fringes 513 does not have the same fringe spacing as the hologram originally recorded in controllably playback shifted hologram 510, therefore set of hologram fringes 513 has different ranges of angles and wavelengths that satisfy the Bragg condition for hologram playback. Controllably playback shifted hologram 510 may comprise a transmission hologram; controllably playback shifted hologram 510 may comprise a reflection hologram.

Controllably playback shifted hologram 510 possesses an incident playback angle, wherein the incident playback angle comprises the range of angles that satisfy the Bragg condition for hologram playback of controllably playback shifted hologram 510. The incident playback angle of controllably playback shifted hologram 510 is at least approximately constant between first surface 511 and second surface 512. The incident playback angle may be greater than 45 degrees, greater than 60 degrees, or greater than 70 degrees. Controllably playback shifted hologram 510 possesses a redirection angle, wherein the redirection angle comprises the difference in angle between the incident playback light and the diffracted playback light. The redirection angle of controllably playback shifted hologram 510 be greater than 45 degrees, greater than 90 degrees, or greater than 140 degrees.

Controllably playback shifted hologram 510 possesses a playback wavelength, wherein the playback wavelength comprises the range of wavelengths that satisfy the Bragg condition for hologram playback of controllably playback shifted hologram 510. The playback wavelength of controllably playback shifted hologram 510 is at least approximately constant between first surface 511 and second surface 512. The playback wavelength may be greater than 680 nanometers, greater than 690 nanometers, greater than 850 nm, or greater than 1000 nanometers. Set of fringes 513 possesses slant angle 515 that is at least approximately constant between first surface 511 and second surface 512. Set of fringes 513 possesses fringe spacing 514 that is at least approximately constant between first surface 511 and second surface 512.

Controllably playback shifted hologram 510 may comprise a wavelength-multiplexed hologram, where a wavelength multiplexed hologram comprises at least two wavelength-specific holograms. Controllably playback shifted hologram 510 may comprise a red hologram, a green hologram, and a blue hologram.

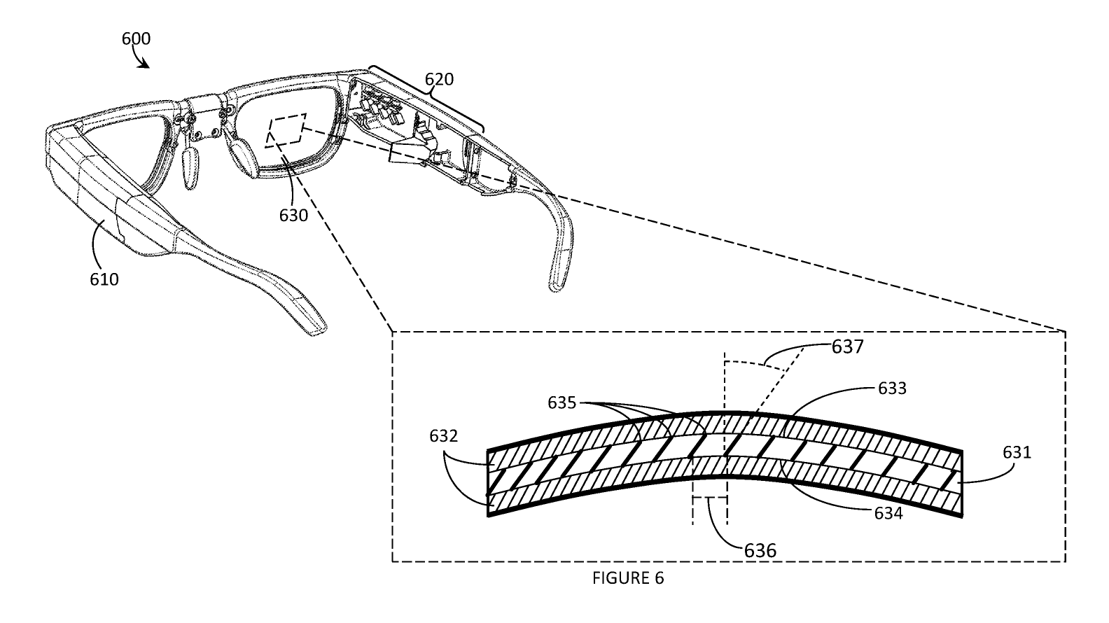

FIG. 6 is a partial-cutaway perspective view of a WHUD 600 that includes an eyeglass lens 630 with an embedded controllably playback shifted hologram 631 in accordance with the present systems, devices, and methods. Eyeglass lens 630 may be substantially similar to eyeglass lens 500 from FIG. 5. Embedded controllably playback shifted hologram 631 may be substantively similar to controllably playback shifted hologram 200. WHUD 600 comprises a support structure 610 that is worn on the head of the user and has a general shape and appearance of an eyeglasses (e.g., sunglasses) frame. Support structure 610 carries multiple components, including: an image source 620, and an eyeglass lens 630. Image source 620 is positioned and oriented to direct light towards the eyeglass lens and may include, for example, a micro-display system, a scanning laser projection system, or another system for generating display images. FIG. 6 provides a partial-cutaway view in which regions of support structure 610 have been removed in order to render visible portions of image source 620 and clarify the location of image source 620 within WHUD 600. Eyeglass lens 630 is positioned within a field of view of an eye of the user when the support structure is worn on the head of the user and serves as both a conventional eyeglass lens (i.e., prescription or non-prescription depending on the needs of the user) and a transparent combiner. Image source 620 may be positioned closer to eyeglass lens 630 relative to a WHUD comprising a transparent combiner lacking a hologram with controllably shifted playback.

Eyeglass lens 630 comprises controllably playback shifted hologram 631 and lens assembly 632. Controllably playback shifted hologram 631 comprises first surface 633, second surface 634, and set of fringes 635. Second surface 634 is opposite first surface 633. Set of fringes 635 is disposed between first surface 633 and second surface 634. Controllably playback shifted hologram 631 may have a thickness less than 0.1 mm; in the alternative, controllably playback shifted hologram 631 may have a thickness up to 1 mm. Controllably playback shifted hologram 631 may be curved; if controllably playback shifted hologram 631 is curved then first surface 633 and second surface 634 are necessarily curved. The center or axis of curvature, as appropriate, of controllably playback shifted hologram 631 may be located at a distance of between 1 and 10 centimeters, between 10 and 50 cm, or between 50 and 100 cm from either first surface 633 or second surface 634.

Due to the controllable playback shifting that was previously applied to controllably playback shifted hologram 631, set of hologram fringes 635 does not have the same fringe spacing as the hologram originally recorded in controllably playback shifted hologram 631, therefore set of hologram fringes 635 has different ranges of angles and wavelengths that satisfy the Bragg condition for hologram playback. Controllably playback shifted hologram 631 may comprise a transmission hologram; controllably playback shifted hologram 631 may comprise a reflection hologram.

Controllably playback shifted hologram 631 possesses an incident playback angle, wherein the incident playback angle comprises the range of angles that satisfy the Bragg condition for hologram playback of controllably playback shifted hologram 631. The incident playback angle of controllably playback shifted hologram 631 is at least approximately constant between first surface 633 and second surface 634. The incident playback angle may be greater than 45 degrees, greater than 60 degrees, or greater than 70 degrees. Controllably playback shifted hologram 631 possesses a redirection angle, wherein the redirection angle comprises the difference in angle between the incident playback light and the diffracted playback light. The redirection angle of controllably playback shifted hologram 631 be greater than 45 degrees, greater than 90 degrees, or greater than 140 degrees.

Controllably playback shifted hologram 631 possesses a playback wavelength, wherein the playback wavelength comprises the range of wavelengths that satisfy the Bragg condition for hologram playback of controllably playback shifted hologram 631. The playback wavelength of controllably playback shifted hologram 631 is at least approximately constant between first surface 633 and second surface 634. The playback wavelength may be greater than 680 nanometers, greater than 690 nanometers, greater than 850 nm, or greater than 1000 nanometers. Set of fringes 635 possesses slant angle 637 that is at least approximately constant between first surface 633 and second surface 634. Set of fringes 635 possesses fringe spacing 636 that is at least approximately constant between first surface 633 and second surface 634.

Controllably playback shifted hologram 631 may comprise a wavelength-multiplexed hologram, where a wavelength multiplexed hologram comprises at least two wavelength-specific holograms. Controllably playback shifted hologram 510 may comprise a red hologram, a green hologram, and a blue hologram.

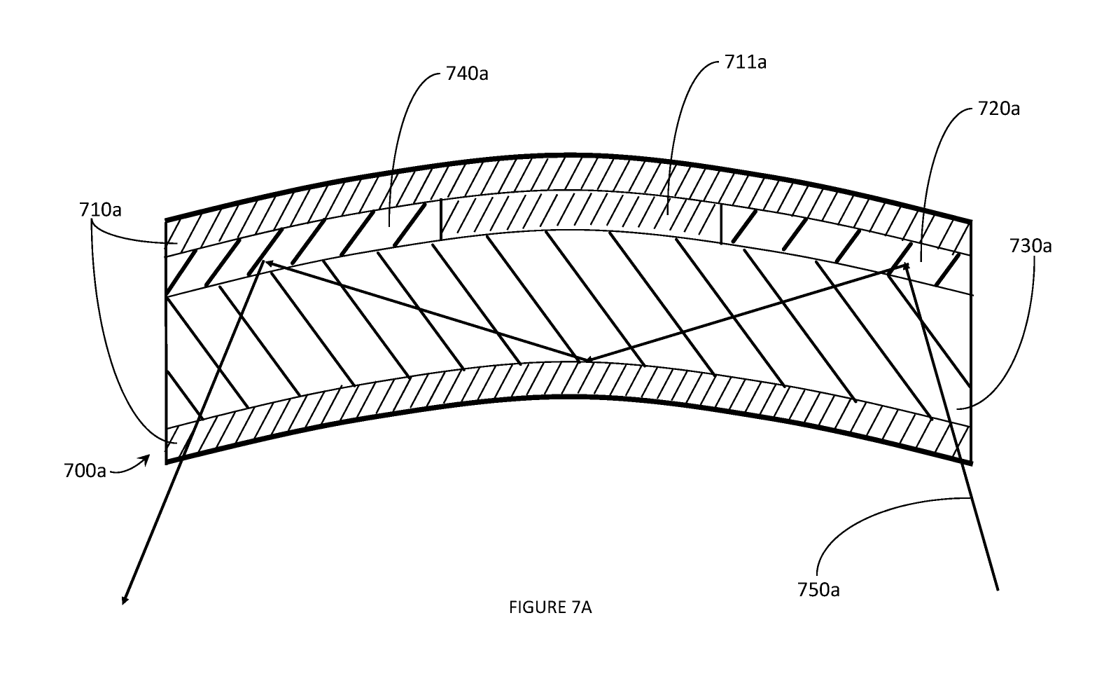

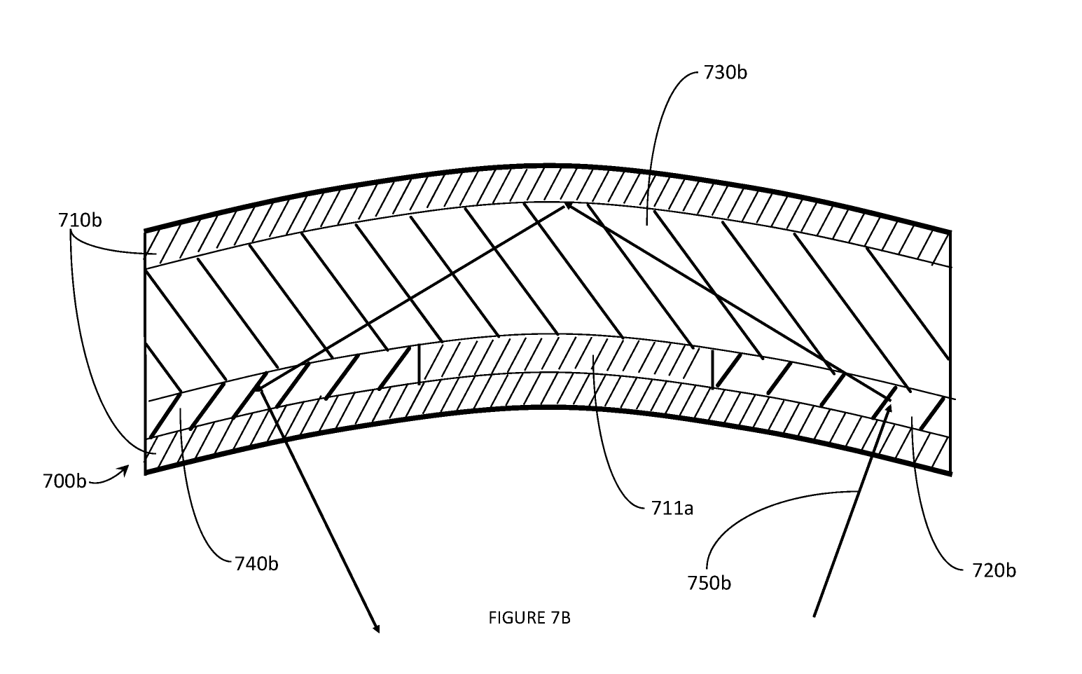

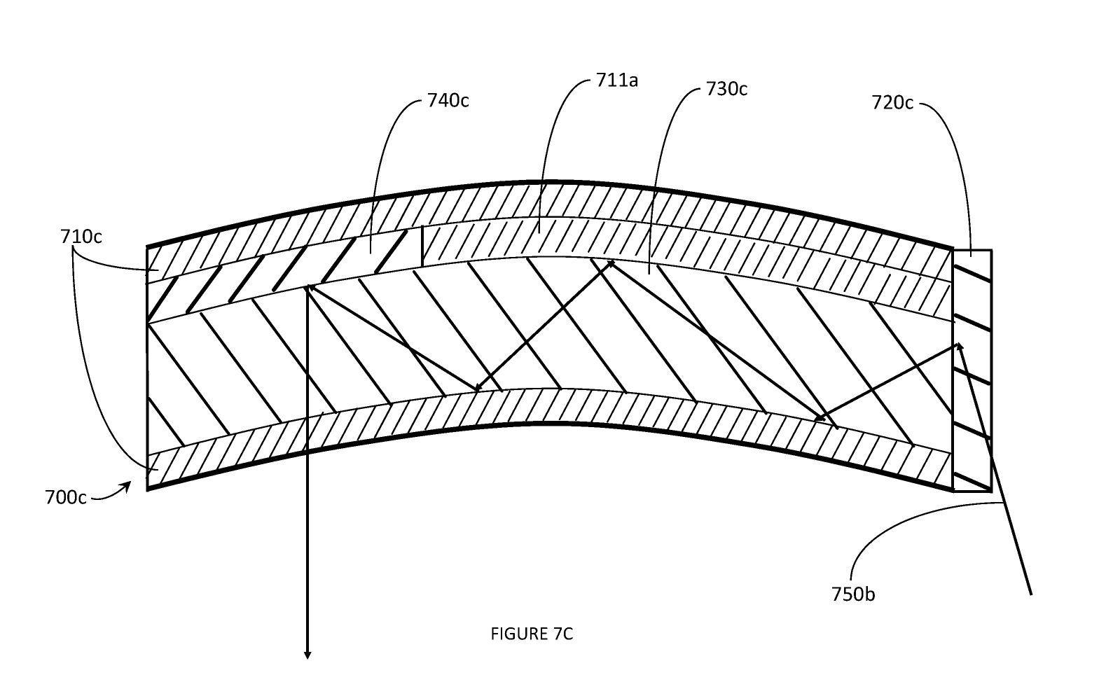

FIG. 7A is a cross-sectional view of an exemplary eyeglass lens 700a suitable for use in a WHUD in accordance with the present systems, devices, and methods. Eyeglass lens 700a comprises lens assembly 710a, interstitial region 711a, in-coupler 720a, light guide 730a, and out-coupler 740a. At least one of in-coupler 720a and out-coupler 740a comprises a controllably playback shifted hologram. At least one of in-coupler 720a and out-coupler 740a may be substantively similar to controllably playback shifted hologram 200.

Beam of light 750a may enter exemplary eyeglass lens 700a and impinge on in-coupler 720a. Beam of light 750a is redirected into light guide 730a by in-coupler 720a at an angle greater than the critical angle of light guide 730a; light beam 750a therefore reflects off the surface of light guide 730a at least once. In other words, light beam 750a is redirected by in-coupler 720a at an angle such that beam of light 750a experiences total internal reflection within light guide 730a.

After reflecting off the surface of light guide 730a at least once, light beam 750a impinges on out-coupler 740a. Out-coupler 740a redirects beam of light 750a at an angle less than the critical angle of light guide 730a; beam of light 750a therefore exits light guide 730a. Eyeglass lens 700a may be employed in a light guide based wearable heads-up display. In-coupler 720a and out-coupler 740a may be separated from one another in space by interstitial region 711a; interstitial region 711a may comprise material substantively similar to lens assembly 710a.

Lens assembly 710a may advantageously possess a refractive index lower than the refractive index of light guide 730a. Each of in-coupler 720a and out-coupler 740a may advantageously possess a refractive index at least approximately the same as the refractive index of light guide 730a. If in-coupler 720a comprises a controllably playback shifted hologram then in-coupler 720a comprises a reflection hologram. If out-coupler 740a comprises a controllably playback shifted hologram then out-coupler 740a comprises a reflection hologram.

FIG. 7B is a cross-sectional view of an exemplary eyeglass lens 700b suitable for use in a WHUD in accordance with the present systems, devices, and methods. Eyeglass lens 700b comprises lens assembly 710b, interstitial region 711b, in-coupler 720b, light guide 730b, and out-coupler 740b. At least one of in-coupler 720b and out-coupler 740b comprises a controllably playback shifted hologram. At least one of in-coupler 720b and out-coupler 740b may be substantively similar to controllably playback shifted hologram 200. Eyeglass lens 700b is substantively similar to eyeglass lens 700a, however if in-coupler 720b comprises a controllably playback shifted hologram then in-coupler 720b comprises a transmission hologram and if out-coupler 740b comprises a controllably playback shifted hologram then out-coupler 740b comprises a transmission hologram. Beam of light 750b may be redirected into, through, and out of, light guide 730b in a manner substantively similar to the redirection of beam of light 730a through light guide 730a. Eyeglass lens 700b may be employed in a light guide based wearable heads-up display.

FIG. 7C is a cross-sectional view of an exemplary eyeglass lens 700c suitable for use in a WHUD in accordance with the present systems, devices, and methods. Eyeglass lens 700c comprises lens assembly 710c, interstitial region 711c, in-coupler 720c, light guide 730c, and out-coupler 740c. At least one of in-coupler 720c and out-coupler 740c comprises a controllably playback shifted hologram. At least one of in-coupler 720c and out-coupler 740c may be substantively similar to controllably playback shifted hologram 200. Eyeglass lens 700c is substantively similar to eyeglass lens 700a, however if in-coupler 720b comprises a controllably playback shifted hologram then in-coupler 720b comprises a transmission hologram and if out-coupler 740b comprises a controllably playback shifted hologram then out-coupler 740b comprises a reflection hologram. Beam of light 750b may be redirected into, through, and out of, light guide 730b in a manner substantively similar to the redirection of beam of light 730a through light guide 730a. Eyeglass lens 700b may be employed in a light guide based wearable heads-up display.

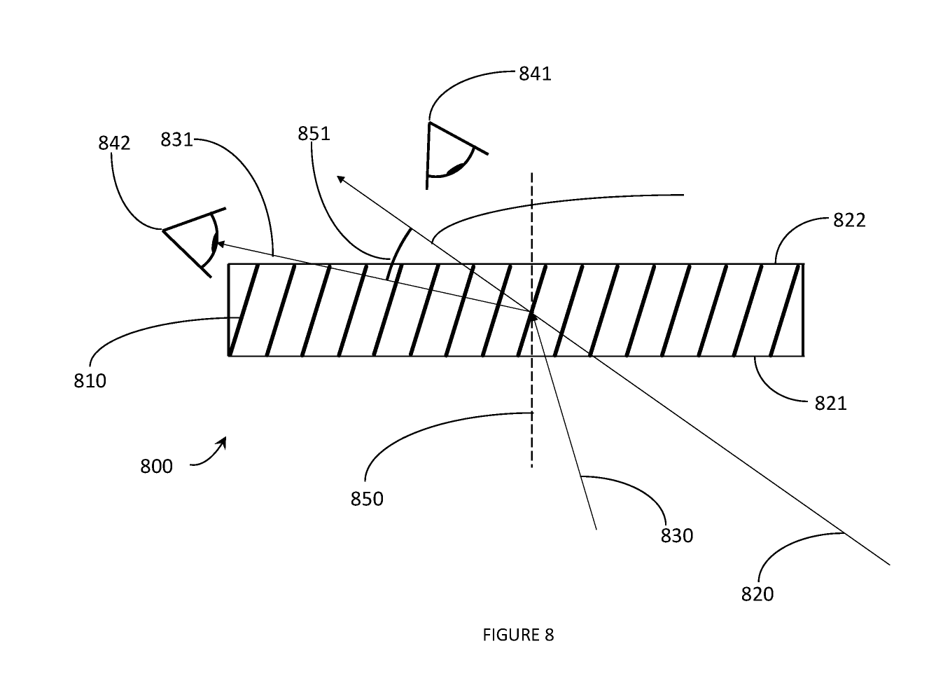

FIG. 8 is a cross-sectional view of controllably playback shifted hologram 800 in accordance with the present systems, devices, and methods. Controllably playback shifted hologram 800 comprises first set of fringes 810, first surface 821, and second surface 822. Second surface 822 is opposite first surface 821. Set of fringes 810 is disposed between first surface 821 and second surface 822. Controllably playback shifted hologram 800 is substantively similar to controllably playback shifted hologram 200, however controllably playback shifted hologram 800 comprises a transmission hologram while controllably playback shifted hologram 200 comprises a reflection hologram.

A person of skill in the art will appreciate that the various embodiments for holograms with controllably shifted playback described herein may be applied in non-WHUD applications. For example, the present systems, devices, and methods may be applied in non-wearable heads-up displays and/or in other applications that may or may not include a visible display.

In some implementations, one or more optical fiber(s) may be used to guide light signals along some of the paths illustrated herein.

The WHUDs described herein may include one or more sensor(s) (e.g., microphone, camera, thermometer, compass, altimeter, and/or others) for collecting data from the user's environment. For example, one or more camera(s) may be used to provide feedback to the processor of the WHUD and influence where on the display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060, all of which are incorporated by reference herein in their entirety.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: US Patent Application Publication No. US 2015-0378161 A1, US Patent Application Publication No. 2016-0377866 A1 U.S. Non-Provisional patent application Ser. No. 15/046,234, U.S. Non-Provisional patent application Ser. No. 15/046,254, US Patent Application Publication No. US 2016-0238845 A1, U.S. Non-Provisional patent application Ser. No. 15/145,576, U.S. Non-Provisional patent application Ser. No. 15/145,609, U.S. Non-Provisional patent application Ser. No. 15/147,638, U.S. Non-Provisional patent application Ser. No. 15/145,583, U.S. Non-Provisional patent application Ser. No. 15/256,148, U.S. Non-Provisional patent application Ser. No. 15/167,458, U.S. Non-Provisional patent application Ser. No. 15/167,472, U.S. Non-Provisional patent application Ser. No. 15/167,484, U.S. Provisional Patent Application Ser. No. 62/271,135, U.S. Non-Provisional patent application Ser. No. 15/331,204, US Patent Application Publication No. US 2014-0198034 A1, US Patent Application Publication No. US 2014-0198035 A1, U.S. Non-Provisional patent application Ser. No. 15/282,535, U.S. Provisional Patent Application Ser. No. 62/268,892, U.S. Provisional Patent Application Ser. No. 62/322,128, US Patent Application Publication No. US 2017-0068095 A1, US Patent Application Publication No. US 2017-0212290 A1, U.S. Provisional Patent Application Ser. No. 62/487,303, U.S. Provisional Patent Application Ser. No. 62/534,099, U.S. Provisional Patent Application Ser. No. 62/565,677, U.S. Provisional Patent Application Ser. No. 62/482,062, U.S. Provisional Patent Application Ser. No. 62/637,059, and U.S. Provisional Patent Application Ser. No. 62/702,657 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A hologram with controllably shifted playback, the hologram comprising:
a first surface;
a second surface opposite the first surface;
a set of fringes disposed between the first surface and the second surface;
holographic recording medium (“HRM”) material, where the concentration of HRM material is at least approximately constant between the first surface and the second surface; and
donor material, where the concentration of donor material is at least approximately constant between the first surface and the second surface.

2. The hologram of claim 1 wherein the hologram possesses an incident playback angle that is at least approximately constant between the first surface and the second surface.

3. The hologram of claim 1 wherein the hologram possesses an incident playback angle greater than 45 degrees.

4. The hologram of claim 1 wherein the hologram possesses a redirection angle greater than 45 degrees.

5. The hologram of claim 1 wherein the hologram possesses a playback wavelength that is at least approximately constant between the first surface and the second surface.

6. The hologram of claim 1 wherein the hologram possesses a playback wavelength greater than 680 nanometers.

7. The hologram of claim 1 wherein the set of fringes possesses a slant angle that is at least approximately constant between the first surface and the second surface.

8. The hologram of claim 1 wherein the set of fringes possesses a fringe spacing that is at least approximately constant between the first surface and the second surface.

9. An apparatus for controllable shifting of the playback angle of a hologram, the apparatus comprising:
a hologram film holder arranged to controllably physically couple a hologram film to a donor film, wherein the hologram film holder is transparent;
a donor film holder arranged to controllably physically couple the donor film to the hologram film;
a first light source positioned and oriented to illuminate at least a portion of the hologram film when held by the hologram holder with a first beam of incident playback light;
a first light sensor positioned and oriented to measure an intensity of playback light emanating from the hologram film when held by the hologram film holder; and
a controllable curing lamp positioned and oriented to illuminate the hologram film with light when the hologram film is held by the hologram film holder, wherein the range of wavelengths of light emitted by the curing lamp is different from the range of wavelengths of light emitted by the first light source.

10. The apparatus of claim 9 wherein the angle between the first light source and the first light sensor is greater than 140 degrees.

11. The apparatus of claim 9 wherein the first light source comprises an infrared light source.

12. The apparatus of claim 9 wherein:
the hologram film comprises a portion of a roll of hologram film, wherein the roll of hologram film is positioned and oriented to hold said portion of the roll of hologram film in the hologram film holder;
the donor film comprises a portion of a roll of donor film, wherein the roll of donor film is positioned and oriented to hold said portion of the roll of donor film in the donor film holder;
the hologram film holder is arranged to controllably physically couple the hologram film to the donor film by placing tension on the roll of hologram film; and
the donor film holder is arranged to controllably physically couple the donor film to the hologram film by placing tension on the roll of donor film.

13. The apparatus of claim 9 wherein the angle between the first light source and the first light sensor is at least 90 degrees.

14. The apparatus of claim 9 wherein the second light source comprises a visible light source.

15. A method for controllable shifting of the playback of holograms, the method comprising:
physically coupling a donor film to a hologram film, wherein the donor film comprises donor material, the hologram film comprises a hologram, and wherein physically coupling the donor film to the hologram film causes a first amount of donor material to diffuse from the donor film into the hologram film;
monitoring a playback light of the hologram of the hologram film until a first amount of playback shifting has occurred;
in response to achieving the first amount of playback shifting: fixing the hologram film; and
physically de-coupling the donor film from the hologram film.

16. The method of claim 15, wherein physically coupling a donor film to the hologram film includes forming an interface between the donor film and the hologram film to cause the first amount of donor material to diffuse from the donor film across the interface into the hologram film.

17. The method of claim 15, further comprising:
monitoring the playback light of the hologram of the hologram film until an additional amount of playback shifting has occurred; and
equilibrating donor material within the hologram film, wherein equilibrating donor material within the hologram film includes causing diffusion of donor material within the hologram film absent diffusion of donor material from the donor film into the hologram film to achieve a first amount of playback shifting;
wherein physically de-coupling the donor film from the hologram film includes physically de-coupling the donor film from the hologram film in response to achieving the additional amount of playback shifting.

18. The method of claim 17, wherein monitoring the playback light of the hologram of the hologram film until an additional amount of playback shifting has occurred includes monitoring the playback light of the hologram of the hologram film until a first amount of bandwidth broadening has occurred.

19. The method of claim 15 wherein monitoring a playback light of the hologram of the hologram film includes illuminating the hologram film with infrared light and measuring an intensity of the infrared light diffracted by the hologram.

20. The method of claim 15 wherein monitoring a playback light of the hologram of the hologram film includes illuminating the hologram film with light of a wavelength to which the donor material is insensitive.

21. The method of claim 15, further comprising:
physically coupling an additional donor film to the hologram film to cause a second amount of donor material to diffuse from the donor film into the hologram film;
monitoring the playback light of the hologram of the hologram film until a second amount of playback shifting has occurred;
in response to achieving the second amount of playback shifting: fixing the second amount of donor material; and
physically de-coupling the additional donor film from the hologram film.

22. The method of claim 15 wherein monitoring a playback light of the hologram of the hologram film until a first amount of playback shifting has occurred includes monitoring a playback light of the hologram of the hologram film until the hologram of the hologram film possesses a playback wavelength of at least 680 nanometers.

23. An eyeglass lens for use in a wearable heads-up display, the eyeglass lens comprising:
a hologram comprising:
a first surface;
a second surface opposite the first surface; and
a set of fringes disposed between the first surface and the second surface;
holographic recording medium (“HRM”) material, where the concentration of HRM material is at least approximately constant between the first surface and the second surface; and
donor material, where the concentration of donor material is at least approximately constant between the first surface and the second surface; and
at least one lens portion, wherein each lens portion is physically coupled to the hologram.

24. The lens of claim 23 wherein the hologram possesses a playback wavelength greater than 680 nanometers.

25. The lens of claim 23, further comprising a light guide and an out-coupler, wherein the hologram comprises a holographic in-coupler.

26. The lens of claim 23, further comprising a light guide and an in-coupler, wherein the hologram comprises a holographic out-coupler.

27. The lens of claim 26, wherein the in-coupler comprises a holographic in-coupler, the holographic in-coupler comprising:
a first surface;
a second surface opposite the first surface;
a set of fringes disposed between the first surface and the second surface;
holographic recording medium (“HRM”) material, where the concentration of HRM material is at least approximately constant between the first surface and the second surface; and
donor material, where the concentration of donor material is at least approximately constant between the first surface and the second surface.

28. A wearable heads-up display (WHUD) with an expanded eyebox, the wearable heads-up display comprising:
a support structure;
a projector; and
a transparent combiner positioned and oriented to appear in a field of view of an eye of a user when the support structure is worn on a head of the user, the transparent combiner comprising:
a hologram comprising:
a first surface;
a second surface opposite the first surface; and
a set of fringes disposed between the first surface and the second surface;
holographic recording medium (“HRM”) material, where the concentration of HRM material is at least approximately constant between the first surface and the second surface; and
donor material, where the concentration of donor material is at least approximately constant between the first surface and the second surface; and
at least one lens portion, wherein each lens portion is physically coupled to the hologram.

29. The WHUD of claim 28 wherein the hologram possesses a playback wavelength greater than 680 nanometers.

30. The WHUD of claim 28, wherein the lens further comprises a light guide and an out-coupler, wherein the hologram comprises a holographic in-coupler.

31. The WHUD of claim 28, wherein the lens further comprises a light guide and an in-coupler, wherein the hologram comprises a holographic out-coupler.

32. The WHUD of claim 31 wherein the in-coupler comprises a holographic in-coupler, the holographic in-coupler comprising:
a first surface;
a second surface opposite the first surface;
a set of fringes disposed between the first surface and the second surface;
holographic recording medium (“HRM”) material, where the concentration of HRM material is at least approximately constant between the first surface and the second surface; and
donor material, where the concentration of donor material is at least approximately constant between the first surface and the second surface.
